(19) United States
(12) Patent Application Publication
(10) Pub. No.: US 2023/0244691 A1
(43) Pub. Date: Aug. 3, 2023

(54) REPLICATION USING DATA IDENTITY

(71) Applicant: Nutanix, Inc., San Jose, CA (US)

(72) Inventors: Niranjan Sanjiv PENDHARKAR, Pune (IN); Shubham Mangilal Sharma, Pune (IN); Kiran TATIPARTHI, Dublin, CA (US)

(73) Assignee: Nutanix, Inc., San Jose, CA (US)

(21) Appl. No.: 17/589,777

(22) Filed: Jan. 31, 2022

(51) Int. Cl. G06F 16/27

(52) U.S. Cl. CPC G06F 16/27

(57) ABSTRACT

Label-based replication of data between two computing clusters. A replication session is established between a source cluster and a target cluster. After making a data item status inquiry originating from the source cluster, the target cluster assesses its then-current status of the data item. Based at least in part on the target cluster's then-current status of the data item, the source cluster determines that at least a portion of the data item can be streamed from the source cluster to the target cluster. As such, rather than making further inquiries to the target cluster as pertains to constituent contents of the data item, the constituent contents of the data item are sent to the target without incurring the protocol costs of making further inquiries. The target cluster determines its then-current status of the data item based on a data item label taken from an entry of a cluster data manifest.

### TECHNICAL FIELD

This disclosure relates to computer cluster systems, and more particularly to techniques for dynamically selecting an inter-cluster replication protocol based on a data status indication.

### BACKGROUND

The emergence of hyperconverged computing infrastructure (HCI) including computing clusters has been a boon to users of computing systems as well as to those who maintain computer clusters. In the latter case, maintenance of hyperconverged computing infrastructure has become nearly as simple as merely connecting a computing node to the LAN of a computer cluster, and then identifying the newly-added node to a cluster controller of the cluster. When the node is brought into the cluster, the resources of the newly-added computing node become available as hyperconverged computing infrastructure and the cluster is expanded in terms of processing power, network bandwidth, and storage capacity. As HCI computing is broadly adopted, the amount of stored data of these computing clusters has become larger and larger, sometimes comprising hundreds or thousands of nodes, and sometimes comprising many hundreds of terabytes of storage or even petabytes or exabytes of storage. Moreover, the amount of stored data grows—seemingly unboundedly—as more and more users are assigned to the cluster and as more and more users generate more and more data.

The need to provide high availability for ongoing expansion of stored data motivates deployers and maintainers of HCI systems to provide backup facilities to be brought to bear in the event of a disaster or other loss of functionality of the cluster. In some cases, and entire backup cluster is replicated in a geographic location that is sufficiently distant from the active cluster such that in the event of a disaster or other event that interrupts availability of the active cluster, the backup cluster can be brought to bear. Users can be automatically switched over to the backup cluster while the outage is remediated. Thus, high availability to the stored data is assured, that is, so long as the backup cluster has the same data as was present at the active cluster.

As such, the need to continuously maintain synchronicity between the active cluster and the backup cluster brings to the fore the need for highly efficient data communication from the active cluster to the backup cluster. This need is accentuated when considering that a backup cluster needs to be initially configured to have the same data as the active cluster. That is, not only does the backup cluster need to be kept in synchronicity with the active cluster as users on the active cluster generate more and more data, but also, the backup cluster needs to be initialized at some point time to have replicas of all of the data of the active cluster. As heretofore indicated, an active cluster might comprise many hundreds of terabytes of storage or even petabytes or exabytes of storage. This illustrates the need for a highly efficient means (e.g., a highly efficient communication protocol) to communicate data from a source location (e.g., from the active cluster) to a target location (e.g., a backup cluster located distally from the active cluster).

Unfortunately, legacy communication protocols (e.g., inter-cluster replication protocols) incur unnecessary communication latency over LANs or WANs. Specifically, when carrying out a protocol to determine whether or not to send data to be replicated at a remote site, legacy protocols often incur unnecessary messaging. This unnecessary communication and associated latency-incurring messaging becomes extreme when the remote site is situated far from the originating site (i.e., thus incurring long latencies for each message). Therefore, what is needed is a technique or techniques that address how to avoid carrying out latency-incurring messaging by and between a source cluster and a target cluster.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and in computer program products for inter-cluster data replication using data status, which techniques advance the relevant technologies to address technological issues with legacy approaches. More specifically, the present disclosure describes techniques used in systems, methods, and in computer program products for inter-cluster data replication using data labeling.

The disclosed embodiments modify and improve over legacy approaches. In particular, the herein-disclosed techniques provide technical solutions that address the technical problems attendant to wasteful usage of computer resources when performing inter-cluster data replication. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication. For example, when implementing the disclosed techniques, computer resources (e.g., memory usage, CPU cycles demanded, network bandwidth demanded, etc.) are significantly reduced as compared to the resources that would be needed but for practice of the herein-disclosed techniques.

Some embodiments include a sequence of instructions that are stored on a non-transitory computer readable medium. Such a sequence of instructions, when stored in memory and executed by one or more processors, causes the one or more processors to perform a set of acts for efficient inter-cluster data replication.

Some embodiments include the aforementioned sequence of instructions that are stored in a memory, which memory is interfaced to one or more processors such that the one or more processors can execute the sequence of instructions to cause the one or more processors to implement acts for efficient inter-cluster data replication.

In various embodiments, any sequence and/or combination of any of the above can be organized to perform any variation of acts for inter-cluster data replication using data labeling, and many such sequences and/or combinations of aspects of the above elements are contemplated.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1A1, FIG. 1A2 and FIG. 1A3 exemplify environments in which embodiments of the disclosure can be implemented.

FIG. 1B1 and FIG. 1B2 depict two different savings regimes that can be applied when dynamically determining which protocol phases can be advantageously eliminated when an inter-cluster replication protocol is being carried out, according to some embodiments.

FIG. 2A shows a data item labeling technique that can be advantageously applied when dynamically determining when to carry out specific portions of a reduced latency inter-cluster replication protocol, according to an embodiment.

FIG. 2B shows cluster data manifest field representations as used in systems that dynamically determine when to carry out an inquiry phase of an inter-cluster replication protocol and when to carry out a data send phase of an inter-cluster replication protocol, according to an embodiment.

FIG. 3A and FIG. 3B illustrate uses of an inter-cluster replication protocol as is used in systems that dynamically determine when to carry out an inquiry phase of an inter-cluster replication protocol and when to carry out a data send phase of an inter-cluster replication protocol, according to an embodiment.

FIG. 3C shows a flowchart that illustrates high-performance inter-cluster replication where the two clusters implement counter-based deduplication, according to an embodiment.

FIG. 3D depicts an example deduplication metadata traversal as used in high-performance inter-cluster replication where the two clusters implement counter-based deduplication, according to an embodiment.

FIG. 4A depicts several example labeling cases as are found in systems that dynamically determine when to carry out an inquiry phase of an inter-cluster replication protocol and when to carry out a data send phase of an inter-cluster replication protocol, according to an embodiment.

FIG. 4B depicts several example protocol phase determination methods as are found in systems that dynamically determine when to carry out an inquiry phase of an inter-cluster replication protocol and when to carry out a data send phase of an inter-cluster replication protocol, according to an embodiment.

FIG. 5A, FIG. 5B, FIG. 5C, and FIG. 5D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems to determine when to send an inquiry before sending data versus when to just send data without a corresponding inquiry. Some embodiments are directed to approaches for maintaining a manifest that characterizes stored data items. The accompanying figures and discussions herein present example environments, systems, methods, and computer program products for dynamically determining when to carry out an inquiry phase of an inter-cluster replication protocol and when to carry out a data send phase of an inter-cluster replication protocol.

### Overview

Disclosed herein are techniques for using information in a data catalog or manifest to reduce or eliminate inter-cluster messaging and corresponding latency-incurring operations during the process of carrying out an inter-cluster replication protocol. The disclosed methods support multiple protocols as is depicted in Table 1.

TABLE 1
Data item status-based replication protocol phases

| Essence | Description |
|---|---|
| Inquire and Send | This is a first option of a data status-based |
| | protocol, where a data item status inquiry is |
| | carried out between a source cluster and a |
| | remote target cluster. If, through the inquiry, |
| | it is determined that some portion of the data |
| | corresponding a particular data item is not |
| | found on the target cluster, then the data is |
| | sent from the source to the target without |
| | incurring latency associated with further |
| | inquiries. |
| Inquire and Don't | This is a second option of a data item status-based |
| Send | protocol, where a data item status inquiry is carried |
| | out between a source cluster and a remote target |
| | cluster. If, through the inquiry, it is determined |
| | that certain data corresponding to a portion of a |
| | particular data identifier is found on the target |
| | cluster, then no corresponding data is sent from |
| | the source to the target. |
| Data Streaming | This is a third option of a data item status-based |
| | protocol, where a data item status inquiry is carried |
| | out between a source cluster, and once it is determined |
| | that the data item corresponding to the data identifier |
| | is not found on the target cluster, then constituent |
| | data is streamed from the source to the target without |
| | incurring latency associated with further inquiries |
| | pertaining to the particular constituent data. |
| Pushing Changed | Only the changed data portions (e.g., ranges of |
| Data | changed data) are sent to the remote cluster |
| | without checking with the target for its data |
| | item status. |

Data item status-based replication reduces or eliminates latency-incurring messaging, at least in the sense that, if is known that certain data is likely to be present on a particular remote cluster, then network bandwidth utilization is reduced by eliminating unnecessary replication (e.g., sending) of the data from source to target.

Dynamically determining when to use which phase or phases of a replication protocol for any particular data item so as to avoid latency-incurring messaging is accomplished through use of the disclosed techniques.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

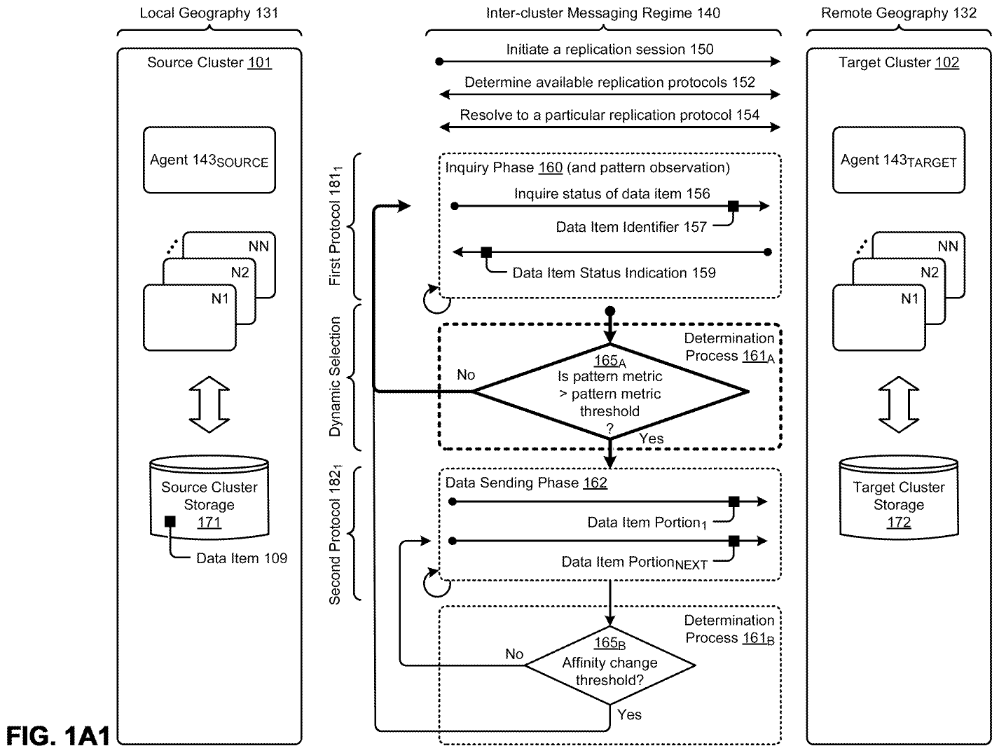

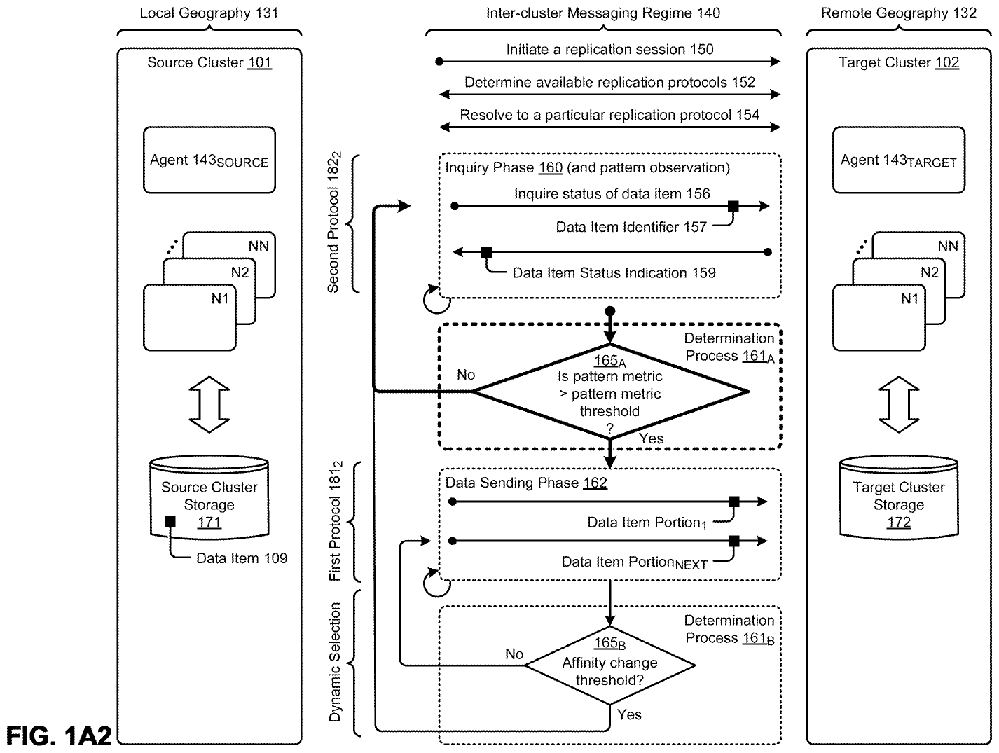

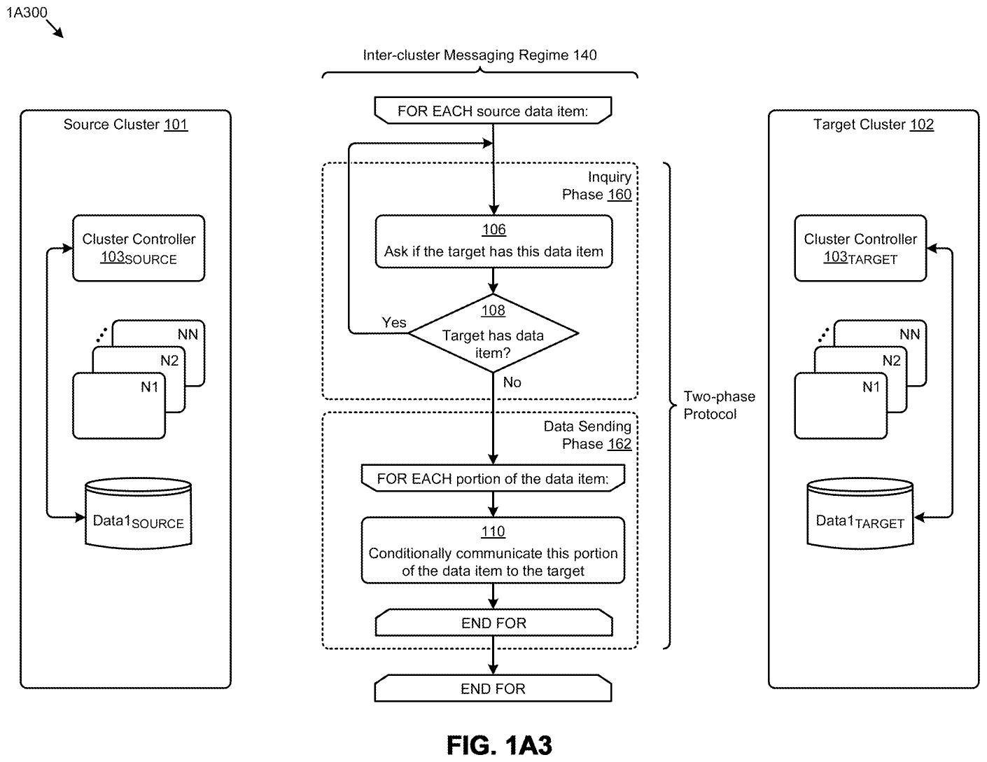

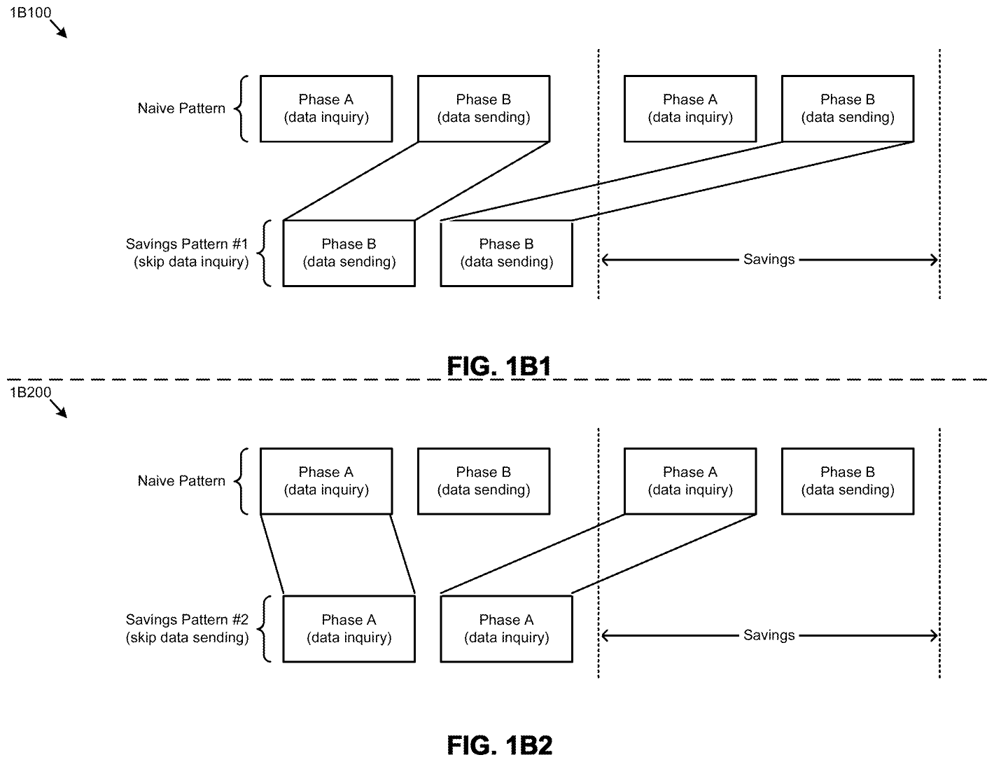

FIG. 1A1, FIG. 1A2, and FIG. 1A3 exemplify environments in which embodiments of the disclosure can be implemented. As an option, one or more variations of the shown inter-cluster messaging regimes or any aspect thereof may be implemented in the context of the architecture and functionality of the embodiments described herein.

FIG. 1A1 exemplifies an environment in which an inter-cluster messaging regime 140 can be practiced. Any aspect of the environment may be varied in the context of the architecture and functionality of the embodiments described herein. As an option, one or more variations of inter-cluster messaging regime 140 or any aspect thereof may be implemented in the context of the architecture and functionality of the embodiments described herein and/or in any alternative environments.

As shown, an inter-cluster messaging regime 140 is carried out between a source cluster 101 in a local geography 131 and a target cluster 102 in a remote geography 132. The source cluster and the target cluster each host corresponding instances of an agent (e.g., agent 143_{SOURCE} and agent 143_{TARGET}). These agent instances serve to carry out messaging such that the shown inter-cluster messaging regime 140 can be carried out at any moment in time. The agent instances can be situated on any computing machinery of or corresponding to a particular cluster. In some cases, an agent instance is situated on a computing node that forms the cluster (e.g., node N1, node N2, . . . , node NN of source cluster 101, or node N1, node N2, . . . , node NN of target cluster 102). In other situations an agent instance is situated on a computing node that is ancillary to the cluster (e.g., on computing machinery that serves as a cluster monitor).

In operation, any of the computing machinery that forms or is used by a particular cluster can access its corresponding storage facilities (e.g., source cluster storage 171, target cluster storage 172). At some moment in time, a backup cluster (e.g., target cluster 102) is associated with an active cluster (e.g., source cluster 101). As such a time, agents of the two clusters are interconnected via a network such that the clusters can initiate a replication session. Such a replication session can be a long-lived session, possibly spanning days or weeks or months. In the particular embodiment as shown in FIG. 1A1, the source cluster initiates a replication session with the target cluster (e.g., via message 150). Next, the two clusters determine a set of available replication protocols (e.g. via exchange 152). There may be many available replication protocols that are configured into the clusters. As such, the two clusters might need to negotiate which one or ones of several replication protocols to use. At some point, the two clusters resolve to an inter-cluster messaging regime that contains a particular replication protocol (via exchange 154).

In the particular embodiment of FIG. 1A1, the resolved-to replication protocol is a multi-phase protocol that includes an inquiry phase 160, one or more determination processes (e.g., determination process 161_{A} and determination process 161_{B}), and a data sending phase 162. Any phase can be initiated at any moment in time, and any sequence or order of carrying out the operations of any phase can be invoked with or without any results of carrying out any particular preceding phase.

In the particular embodiment of FIG. 1A1, an inquiry phase 160 is carried out prior to entering determination process 161_{A}, and a data sending phase 162 is carried out prior to entering into determination process 161_{B}. Information arising from the target cluster's performance of its portion of the inquiry phase is made available to the source cluster. Information such as whether or not the target has a copy of a particular subject data item and/or what label or labels are associated with the subject data item is then used in one or more of the determination processes so as to decide whether to (1) stream data (e.g., as might be the case when the target cluster does not have a copy of the particular subject data item) via iterations of a data sending phase (e.g., for streaming data without intervening inquiries), or whether to (2) continue to make further inquiries (e.g., in the case when the target cluster does already have a copy of that particular subject data item). In exemplary cases, information as to whether or not the target has a copy of a particular subject data item plus a label or labels associated with the subject data item are used in combination such that the source cluster can assess the likelihood that the target cluster does (or does not) have a copy of any further subject data items.

Strictly as one example, a subject data item might be a folder containing many individual files. If the target indicates it does not have that folder in its storage, then the source cluster can reasonably determine that all of the constituent individual files of the folder also won't be at the target cluster, and thus all of the constituent individual files of the folder can be streamed to the target without incurring the protocol costs of making inquiries on an individual-file-by-individual-file basis. In a variation of this example, it might be that the target cluster does have a copy of the folder, and further that the folder and its contents are explicitly marked to be handled as deduplicated items. In that case, the source cluster might make inquiries on an individual-file-by-individual-file basis (e.g., so as to populate individual file entries into a directory or manifest at the target cluster)—yet without sending the actual data contents of the deduplicated items.

In a variation of the deduplication example, it can happen that the source cluster will send data that is explicitly marked as deduplicated. This can happen, for example, when the deduplication configuration specifies that a certain maximum number of copies M, after which no further copies are to be made within a cluster.

As shown, the inquiry phase includes a mechanism to inquire as to the status of a particular data item (e.g., message 156). Such a mechanism to inquire as to the status of a particular data item includes providing a data item identifier 157. Such a data item identifier 157 can use all or portions of any known technique for identifying a particular data item. For example, a data item can be identified by a name of a folder or a name of a file, or by a name or designation of a virtual disk (vDisk), or by name or designation of a virtual disk group, or by a block number or range of block numbers, or by designation of a particular metadata range, or by designation of a particular range of keys of metadata, etc. At least inasmuch as the source cluster and the target cluster had previously resolved to a particular replication protocol, the target cluster can recognize the representation and meaning of any data item identifier provided by the source cluster. The target cluster, having comprehended the meaning of the data item identifier provided by the source cluster, replies to the inquiry with a data item status indication 159. The data item status indication might be a binary value corresponding to “I have it” or “I don't have it”. Additionally or alternatively, the data item status indication might indicate the timestamp of the data item at the target. Additionally or alternatively, the data item status indication might indicate the location of the data item at the target, and/or local namespace designation of the data item at the target.

Now, considering the case that the target cluster repeatedly sends to the source cluster data item status indications having the semantics of “I don't have the specified data item,” then the carrying-out of the first protocol 181₁ completes and the determination process 161_{A} is entered, whereupon the source cluster performs further processing so as to decide if it is appropriate to begin a second protocol 182₁ so as to begin streaming portions of the specified data item. Consider the case that a large folder having many individual constituent items (e.g., files) is being replicated to a target cluster. If the target cluster repeatedly indicates (e.g., via successive responses to inquiries) that it does not have the particular individual constituent item, and that it does not have a next individual constituent item, and that it does not have a following next individual constituent item, then it can be inferred that the target cluster does not have any of the items and therefore, that all of the remaining items of the folder should be sent (e.g., in a stream) without making further inquiries on an item-by-item basis.

Various patterns and/or pattern lengths can be defined. Strictly as one example, the specified data item might be a folder having many constituent files and an initial pattern of successive occurrences of “I don't have the specified data item” might have emerged by operation of the inquiry phase. When an inquiry-response pattern has reached some particular pattern metric (e.g., count-based or length-based pattern metric corresponding to successive, “I don't have the specified data item,” or a ratio metric corresponding to a ratio or fraction of a certain type of response) then the inquiry phase can move to determination process 161_{A}.

There are many ways comprehended by determination process 161_{A} for selecting whether to return to the inquiry phase 160 or for selecting whether to proceed into data sending phase 162. One way for selecting whether and when to proceed into data sending phase is based upon a pattern or other results of carrying out the inquiry phase on an initial subset of the plurality of data items. Strictly as examples, an initial set can be a randomly selected set, and a pattern having a pattern length can be used as a determining factor as to whether and when to move to a different protocol. Additionally or alternatively, a pattern type, or pattern repetition, or other pattern metric can be used as a determining factor. The source cluster can calculate metrics (e.g., length of a pattern or a pattern constituency value, or repeat counts, etc.) of the emerged pattern, and compare the calculated metrics to a threshold value (e.g., a pattern length threshold, a pattern constituency threshold, a repeat count threshold, etc.). If the pattern metric threshold is breached, then the “Yes” branch of decision 165_{A} is taken to enter data sending phase 162 that streams many constituent files of the folder, portion by portion (e.g., file by file, data item portion₁, data item portion_{NEXT}, and so on) to the target cluster without making further inquiries to the target cluster as to the status of the specified portion of the data item. As can be seen, if the folder contains a large number of files, then a significant improvement is garnered by virtue of avoiding intervening inquiries.

If, on the other hand, the pattern length threshold or the pattern constituency ratio has not been breached, then the “No” branch of decision 165_{A} is taken to loop back to the inquiry phase 160, and the inquiry phase continues.

Continuing with the explanation of this FIG. 1A1, consider that during data sending phase 162, which streams many constituent files of the folder, portion by portion, it can happen that the affinity of the portions changes (e.g., when a different subfolder is encountered during streaming, or when a different level of hierarchy is traversed, etc.). Upon such an occurrence, the data sending phase 162 completes, and processing moves to determination process 161_{B}, whereafter decision 165_{B} calculates an affinity metric and evaluates the affinity metric against an affinity threshold. If the affinity threshold has not been breached, then the “No” branch of decision 165_{B} is taken to loop back to the data sending phase 162, and the streaming continues.

On the other hand if the affinity threshold has indeed been breached, then the “Yes” branch of decision 165_{B} is taken and inquiry phase 160 begins again. That is to say, once the affinity threshold has indeed been breached, then the inter-cluster messaging regime operates so as to determine if the data items having the different affinity should or should not be subjected to streaming. The inter-cluster messaging regime accomplishes this by again observing patterns during the inquiry phase.

The shown progression from a first protocol 181₁ into a process for dynamically selecting whether to return to the first protocol or alternatively, to enter into a second protocol 182₁ that serves for copying at least some of the plurality of data items from the source cluster to the target cluster in a stream. This can happen advantageously, for example when there are a large number of constituent files of a folder. And as such, once it is determined that a large number of data items can be sent to the target cluster in a stream—without incurring the processing, bandwidth, and latency costs of making an inquiry for each constituent item—then the streaming can continue until such time as there is a change in affinity (e.g., completion of a current level of hierarchy, traversal to a different level of a hierarchy, progression to another vDisk, etc.). When there is a change in affinity, an affinity threshold test can inform whether processing should continue the streaming, or whether the processing should go back to an inquiry phase. An example embodiment wherein the source cluster is continually and dynamically selecting between deciding to continue the streaming or deciding to go back to an inquiry phase is shown and described as pertains to FIG. 1A2.

FIG. 1A2 shares many aspects with FIG. 1A1, however FIG. 1A2 is being presented to illustrate how the source cluster dynamically selects between continuing the streaming (shown in FIG. 1A2 as first protocol 1812) or whether the processing should go back to an inquiry phase (shown in FIG. 1A2 as second protocol 1822). As can now be understood the source cluster can switch between protocols freely based on some calculated indication that it is at least predictably beneficial to move to a different protocol. As discussed above, one reason to move from one protocol to another protocol is because an inter-cluster communication pattern suggests the target cluster does not yet have some particular data item or its constituents—and thus a streaming protocol is advantageous. Another reason to move from one protocol to another protocol is because of some occurrence on the source that suggests that continuing the aforementioned streaming protocol might not be advantageous any longer.

Various operational aspects of the foregoing inter-cluster messaging can be carried out via variations of an inter-cluster processing flow. Some such variations of an inter-cluster processing flow are shown and described as pertains to FIG. 1A3.

FIG. 1A3 exemplifies an inter-cluster processing flow 1A300. Any aspect of the inter-cluster processing flow may be implemented in the context of the architecture and functionality of the embodiments described herein and/or in any environment. As an option, one or more variations of inter-cluster processing flow 1A300 or any aspect thereof may be implemented in the context of the architecture and functionality of the embodiments described herein and/or in any alternative environments.

As shown, the flow is carried out in a FOR EACH loop that covers a plurality of data items present at the source (e.g., data within data1_{SOURCE} or metadata within cluster controller 103_{SOURCE}), which data items are needed to be available at the target cluster (e.g., within data1_{TARGET} or within cluster controller 103_{TARGET}). However, it might happen that the particular data item of the source cluster is deemed to be not present at the target cluster. This can happen for many reasons. Example reasons why a particular data item might be present at the source cluster but not at the target cluster include (1) the target cluster had not yet been initialized with a copy of the data item; or (2) even though the target cluster had been initialized with a copy of the data item, due to a storage drive failure or storage facility reconfiguration or corruption, the target cluster no longer has a reliable copy of the data item of the source cluster, and so on.

Irrespective of any particular reason, if after carrying out various inter-cluster operations (e.g., corresponding to step 106) it is deemed (e.g., at decision 108) that the target cluster does not have a reliable copy of the data item, then the “No” branch of decision 108 is taken and data sending phase 162 is entered. Within yet another FOR EACH loop, each individual portion of the data item is conditionally communicated (e.g., via iterations of step 110) from the source cluster to the target cluster. As shown, the iterations within the FOR EACH loop around step 110 are accomplished without making further inquiries to the target cluster as to the status of the specified data item.

Strictly as one example where at least some of the individual portions of the data item are conditionally communicated to the target cluster, consider the situation where processing at the source cluster encounters a long series of null data (e.g., filler blocks in a sparsely-populated file). In such a case, so long as the source cluster and the target cluster have a common meaning of what constitutes a filler block, the filler data (e.g., an extent of all ‘0’s) need not be communicated from the source cluster to the target cluster.

Application of the foregoing techniques yields significant improvements in how the computers interoperate. For example, if a particular data item has a large number of subcomponents, then even if only an initial subset is considered (e.g., only a few percent of the total number of subcomponents of the plurality of data items), a significant improvement is still seen by virtue of avoiding intervening inquiries. If the data item size is very large, a very significant improvement is realizable by virtue of avoiding intervening inquiries. If the physical distance between the source cluster and the target cluster is large or, if for any reason the communication latency between the source cluster and the target cluster is long, then a very significant improvement can be realized by virtue of avoiding intervening inquiries.

Of course it can happen that it is deemed (e.g., at decision 108) that the target cluster does have a reliable copy of the data item, in which case the “Yes” branch of decision 108 is taken and a next data item is processed.

The benefits of avoiding intervening inquiries (e.g., when it is known that the data item does not exist at a target cluster) are shown schematically as pertains to FIG. 1B1. Furthermore, the benefits of avoiding data transmissions (e.g., when it is known that the data item does exist at a target cluster) are shown schematically as pertains to FIG. 1B2.

FIG. 1B1 and FIG. 1B2 depict two different savings regimes, specifically saving regime 1B100 and saving regime 1B200. The appropriate saving regime can be applied when dynamically determining which protocol phases can be advantageously eliminated when an inter-cluster replication protocol is being carried out. FIG. 1B1 illustrates how skipping (i.e., not performing) an inquiry phase of an inter-cluster replication protocol results in significant savings, whereas FIG. 1B2 illustrates how skipping (i.e., not performing) a data sending phase of an inter-cluster replication protocol results in significant savings.

The foregoing discussion cover various binary cases where the determination as to when and what phase or phases of a replication protocol should be entered is based on the presence or absence of the subject data item at the target cluster. However, there can be cases where the mere presence or absence of a subject data item at the target cluster is not determinative by itself. To cover such cases, one possibility is to apply a data item labeling technique.

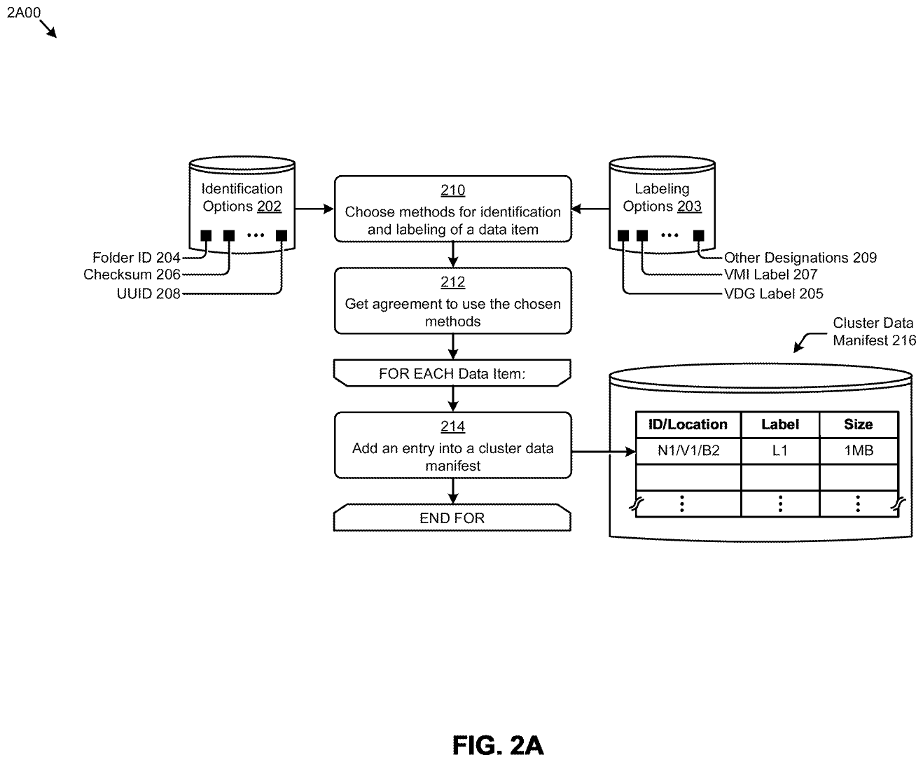

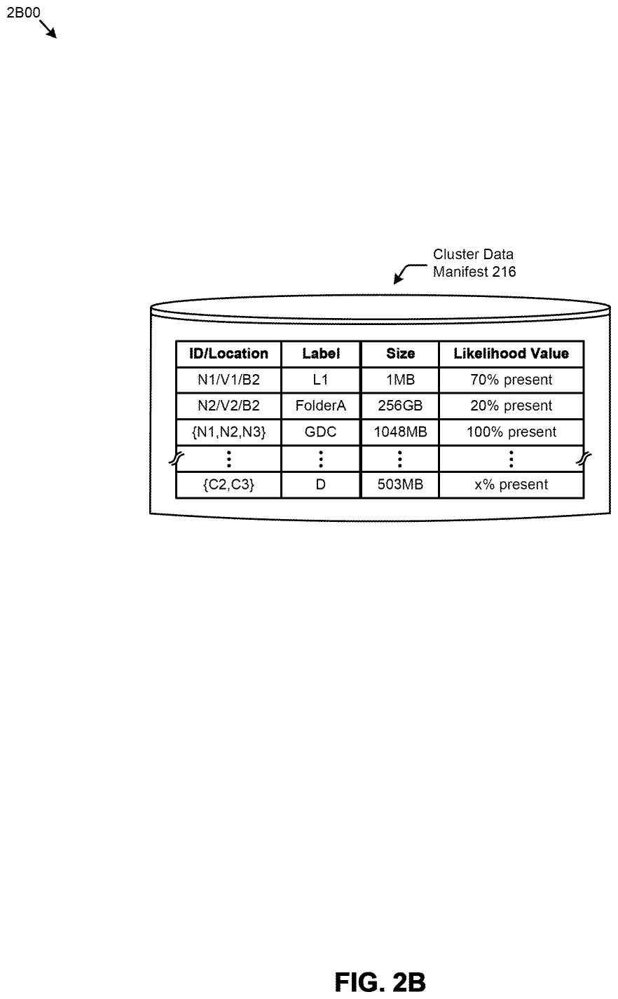

FIG. 2A shows a data item labeling technique 2A00 that can be advantageously applied when dynamically determining when to carry out specific portions of a reduced latency inter-cluster replication protocol. As an option, one or more variations of data item labeling technique 2A00 or any aspect thereof may be implemented in the context of the architecture and functionality of the embodiments described herein and/or in any environment.

The figure is being presented to illustrate one possible technique for configuring a cluster data manifest 216. The technique includes operations for choosing a method for identifying and labeling a data item (step 210), operations for obtaining mutual agreement (e.g., between two computing clusters) to use a particular set of chosen and agreed-to methods (step 212), and operations for populating the cluster data manifest with data item entries (step 214) that are defined in accordance with the particular chosen methods. A FOR EACH loop is shown merely to illustrate that a cluster data manifest can be populated with as many entries as there are data items that could be subject to replication.

This particular embodiment of a cluster data manifest has information organized into three columns: (1) an ID/location column to hold the name and/or location of a particular data item, (2) a label column to hold a value that pertains to the data item of the same row, and (3) a size column that holds a storage size indication that pertains to the data item of the same row.

In some cases, the ID/location of a particular data item might merely refer to a data item that is referenced in a directory. For example, a folder or file might be identified by a folder name or file name, which name has an entry in some form of a logical-to-physical mapping 370 (e.g., a file directory). As such, the actual physical location of the folder (e.g., folder root) or file (e.g., the beginning of a file) can be known by accessing a logical-to-physical mapping and searching for a directory entry corresponding to the folder name or file name.

The representation and semantics of identifiers support many different types of data item identification options 202. Strictly as an example of an identification option, a folder ID 204 might be or refer to a unique folder name, possibly including a volume/directory path. As another example of an identification option, a data item might be identified using a checksum 206 corresponding to all of the bits of a file. As yet another example of an identification option, a data item might be uniquely identified using a universally unique identifier (e.g., UUID 208). A data item can be a storage device or a portion/partition of a storage device, or a data item can be a folder or a data item can be a file, or a range of blocks, or an extent of a storage system, or a range of keys of metadata, etc.

The representation and semantics of labels support many different types of data item labeling options 203. Strictly as an example of a labeling option, a virtual disk image group (e.g., VDG label 205) might be used to indicate that a particular data item is a virtual disk image group. A virtual disk image group often occurs in virtualization systems where a particular virtual machine implements a plurality of virtual disks, where individual ones of the plurality of virtual disks are interrelated by a software application that constitutes at least some of the functions of the virtual machine. When a virtual disk group is encountered for replication, it can be assumed that all of the virtual disk images that constitute the virtual disk image group can be handled together in the same manner. For example, when a virtual disk group is encountered for replication from a source cluster to a target cluster, it can be assumed that all of the virtual disk images that constitute the virtual disk image group can be streamed to the target cluster without the need to inquire as to whether or not the target cluster has (or does not have) a copy of any particular virtual disk image of the virtual disk group.

As another example of a data item labeling option, a VMI label 207 might be used to indicate that a particular data item is a virtual machine image. As yet another example of a data item labeling option, a data item might be labeled with region designations. In many cases, a particular individual data item might be associated with multiple labels. For example, a data item that is a virtual machine image might be labeled both with the VMI label 207 as well as any number of other designations 209 that refer to different regions (e.g., a code region and a data region) of the virtual machine image.

The representation and semantics of the data item identification and labeling serve the purpose of codifying data item entries into a cluster data manifest, however additional information beyond just identification and labeling can be codified into a cluster data manifest entry. One possible set of additional information that can be codified into cluster data manifest entries is shown and described as pertains to FIG. 2B.

FIG. 2B shows cluster data manifest field representations 2B00 as used in systems that dynamically determine when to carry out an inquiry phase of an inter-cluster replication protocol and when to carry out a data send phase of an inter-cluster replication protocol. As an option, one or more variations of cluster data manifest field representations 2B00 or any aspect thereof may be implemented in the context of the architecture and functionality of the embodiments described herein and/or in any environment.

In addition to the fields of the cluster data manifest as heretofore discussed, cluster data manifest field representations of FIG. 2B include a field entitled “Likelihood Value”. Values (e.g., percentages) codified into this field serve to aid a computing process (e.g., the agent of FIG. 1A) in making a determination as to whether or not a particular data item should be the subject of replication at a particular moment in time. In some embodiments, the likelihood value is used to schedule replication of particular data items in a particular order. For example, there are cases of data items that are large (e.g., a folder such as “FolderA” containing files totaling 256 GB of storage) and which have low likelihood values (e.g., 20%). Such data items might be purposely advanced at the expense of delayed replication of smaller data items that have relatively higher likelihood values. As another example, a data item (e.g., “GDC”) that is known to be a copy or descendant of an involatile “gold disk” (e.g., comprising software from a third-party manufacturer) might be labeled with a corresponding label (e.g., “GDC”) to indicate that the data item need not be replicated at all. This is because, in accordance with the semantics of the “gold disk copy” label “GDC”, it can be inferred that all or portions of the data corresponding to that data item can be retrieved from other locations. As yet another example, a deduplicated data item might be labeled with a corresponding label (e.g., “D”) to indicate that the deduplicated data item is expressly not to be replicated.

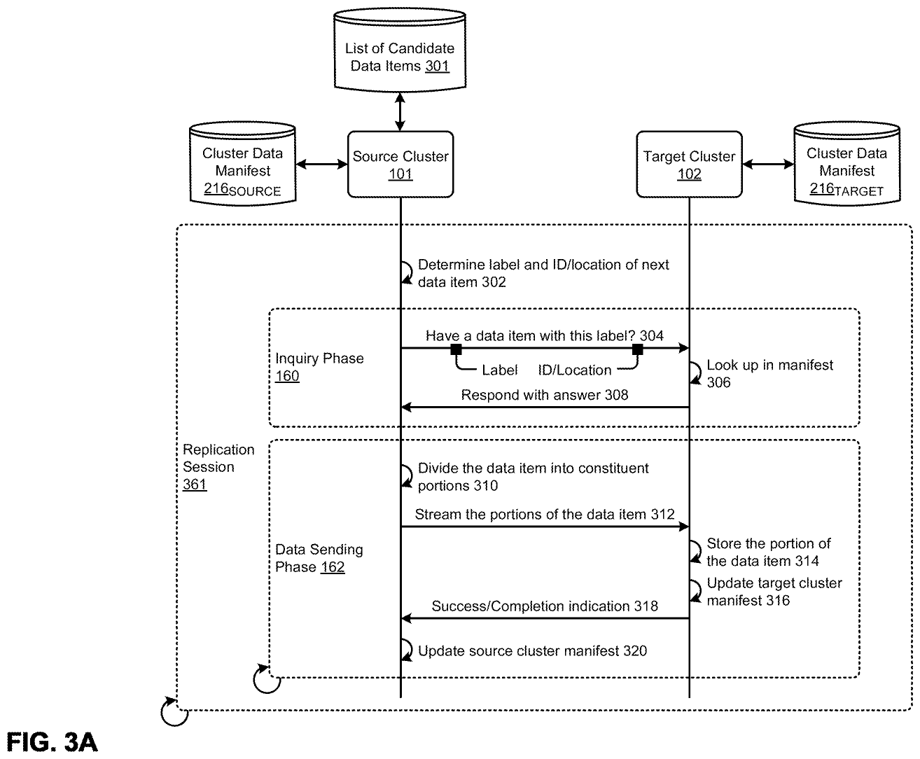

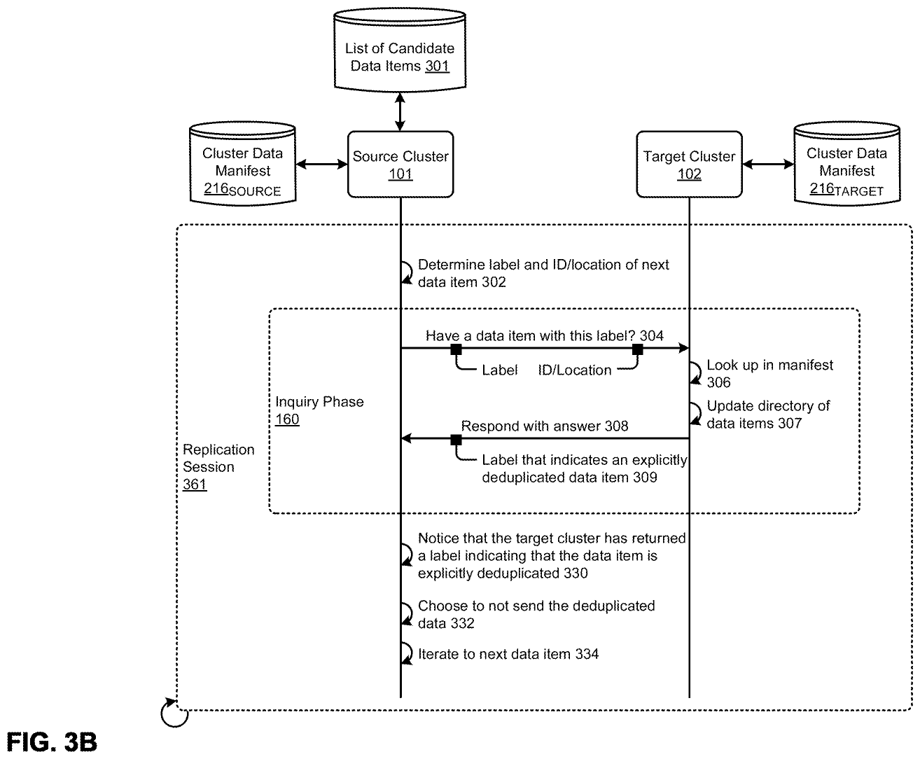

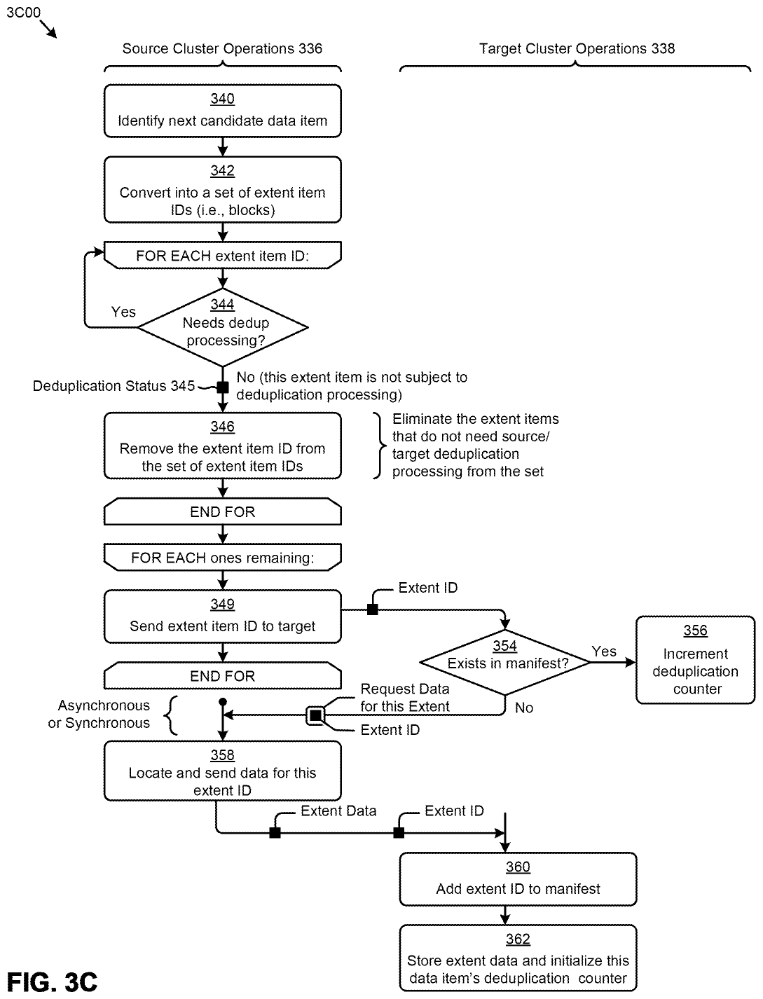

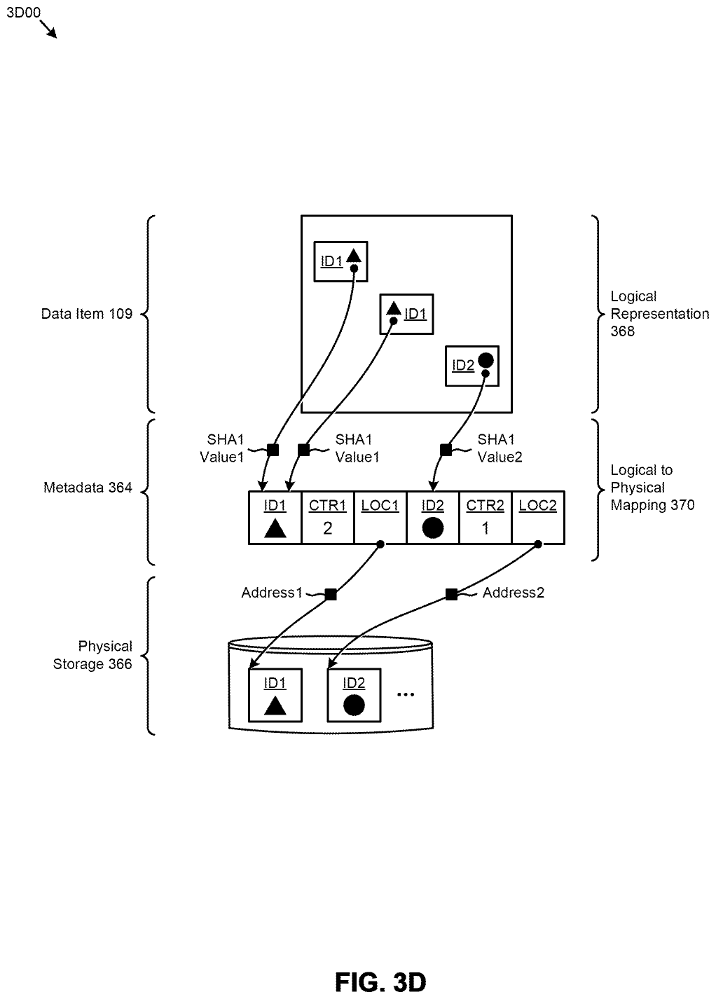

Any of the representations and semantics that are codified into field values of a cluster data manifest can be used in making a determination as to whether a next protocol phase is a data sending phase or an inquiry phase. A sampling of mechanisms for making such a determination and for carrying out the next phase of a replication protocol are shown and discussed as pertains to FIG. 3A and FIG. 3B.

FIG. 3A and FIG. 3B illustrate uses of an inter-cluster replication protocol as is used in systems that dynamically determine when to carry out an inquiry phase of an inter-cluster replication protocol and when to carry out a data send phase of an inter-cluster replication protocol, according to an embodiment. As an option, one or more variations of the inter-cluster replication protocol or any aspect thereof may be implemented in the context of the architecture and functionality of the embodiments described herein and/or in any environment.

FIG. 3A is being presented to illustrate how a source cluster and a target cluster can interoperate during a replication session 361 to make a determination as to whether a next protocol phase is a data sending phase or an inquiry phase. Further, this figure is being presented to illustrate how a source cluster and a target cluster can interoperate to populate data items at a target cluster through use of streaming data items or portions thereof.

In the shown embodiment, source cluster 101 accesses a list of candidate data items 301 so as to consider each data item for replication to the target cluster. In this particular embodiment, source cluster 101 accesses its own manifest copy (e.g., cluster data manifest 216_{SOURCE}) and target cluster 102 accesses its own manifest copy (e.g., cluster data manifest 216_{TARGET}). This configuration is merely one selected illustrative embodiment; other configurations are possible. For example, a single cluster data manifest can be shared by and between source cluster 101 and target cluster 102. Additionally or alternatively, the list of candidate data items 301 can be made unnecessary by merely iterating through data items of the source cluster using any directory structures or metadata structures available to the source cluster.

Source cluster 101 and target cluster 102 communicate via inter-cluster replication protocol. The shown protocol is initiated by the source cluster, where the source cluster selects a next data item for consideration as to whether or not to replicate the data item at the target. More specifically, source cluster 101 determines an ID/location of a next item (operation 302) and packages the ID/location of the next data item together with its corresponding label. Next, the source cluster enters an inquiry phase 160 of the protocol by sending an inquiry message (e.g., message 304) to the target cluster.

Such an inquiry message may contain an ID of the next data item (e.g., a folder name), and/or a location of data items (e.g., an extent and block offset, a table index, etc.). The semantics of such an inquiry message might be “Do you have a copy of the data item referred to by the given ID/Location?” In response, the target cluster accesses its manifest (operation 306).

If the data item referred to by the given ID/Location is present in the target cluster's manifest, then the target responds (e.g., via message 308). The response from the target cluster back to the source cluster might include information pertaining to the then-current status of the data item present at the target cluster. In many cases, the target will reply that it does indeed have a copy of the data item referred to by the given ID/Location. In such cases, there is no need to enter into the data sending phase of the protocol, and instead, the source cluster will iterate to a next data item (operation 302 again). In some cases, it might be that the target cluster has only some portions of the data item referred to by the given ID/Location. In such a case, the target cluster might respond (message 308) to indicate that the target cluster is in need of certain portions of the data item referred to by the given ID/Location. The source cluster can then elect to move into the data sending phase so as to deliver the needed portions of the data item referred to by the given ID/Location.

In cases when the target cluster accesses its manifest (operation 306) and it does not find an entry for the identified data item (e.g., folder), then this indicates that the data item referred to by the given ID/Location is not present at the target cluster. In such a case, the target cluster makes a provisional entry into its manifest (and possibly into its master data item catalog), and then the target responds to the source cluster (e.g., via message 308) that it does not have a copy. The source cluster, in response to receipt of message 308, then determines next steps. The next steps taken are often based (at least in part) on the label corresponding to the data item referred to by the given ID/Location. There are many choices the source cluster can make as for next steps. For example, the source cluster can enter into a data sending phase so as to replicate the data item at the cluster. Alternatively, there are cases where even when the target cluster does not have a copy of the data item referred to by the given ID/Location, the source cluster determines not to enter into the data sending phase so as to avoid replication of the data item at the target cluster. This can happen, for example, in deduplication situations.

In cases when the source cluster determines (e.g., based on the label corresponding to the data item or based on the contents and semantics of message 308) that the data sending phase 162 of the protocol is to be entered, then the source cluster considers if and how the data item can be divided into portions. In some such cases, the source cluster divides the data item into constituent portions (operation 310) before sending the data item or portions thereof to the target cluster (message 312). The target cluster in turn stores the data item or portions thereof (operation 314) at the target and then updates the cluster data manifest (operation 316). Next, the target cluster sends a success/completion indication (message 318) to the source cluster. Responsive to receipt of the aforementioned success/completion indication, the source cluster conditionally updates the cluster data manifest 320 (e.g., cluster data manifest 216_{SOURCE}).

As used herein a cluster data manifest is a data structure that holds or refers to an item of data in a manner that relates the item of data to a data item label.

### Initial Population of a Target Cluster

In some cases, the contents of the data item is sent in chunks over a LAN or WAN or other communication link so as to populate data items to a target cluster. In some cases, a remote direct memory access (RDMA) device is used to establish communication link between the source cluster and the target cluster and to populate data items to a target cluster. In some cases, a target cluster is initially populated using point-in-time data snapshots from a source cluster. In such a case, the replication session 361 is used to populate the target cluster with data items that have changed since creation of its corresponding point-in-time snapshot(s).

Further details regarding general approaches to initially populating a computing cluster are described in U.S. application Ser. No. 15/967,416 entitled “INITIALIZATION OF A DISASTER RECOVERY SITE FROM A PHYSICALLY-TRANSPORTED INITIAL DATASET” filed on Apr. 30, 2018, which is hereby incorporated by reference in its entirety.

FIG. 3B is being presented to illustrate how a source cluster and a target cluster can interoperate in a deduplication scenario to make a determination that a next protocol phase is an inquiry phase. More specifically, this figure is being presented to illustrate how a source cluster and a target cluster can interoperate to avoid sending data that is explicitly deduplicated.

In the shown embodiment, source cluster 101 accesses a list of candidate data items 301 so as to consider each data item for replication to the target cluster. It can happen that when the source cluster inquires (message 304) if the target cluster has a particular data item, the target cluster responds (message 308) with a label (e.g., a deduplicated data item label 309), which indicates (1) that the particular data item is known, by the target cluster, to have an entry in the cluster data manifest 216__{TARGET} of the target cluster; and (2) that the particular data item is known, by the target cluster, to be a data item that is explicitly deduplicated (e.g., as indicated by a data item label within cluster data manifest 216__{TARGET}).

Regardless of whether or not the data item referred to in the inquiry is present at the target, the target updates its directory of data items, which possibly includes updates to the target cluster data manifest (operation 307).

More specifically, and as shown, regardless of whether or not the data item referred to in the inquiry is present at the target, the source cluster can avoid sending the bits of the data item to the cluster by noticing that the target has returned a label corresponding to the semantics that the data item is explicitly deduplicated (operation 330). Based on the semantics that the data item is explicitly deduplicated, the source cluster can choose to not send the bits of the deduplicated data item (operation 332) and instead, merely iterate to the next data item (operation 334).

As used herein, a data item label is a value that is associated with a particular characteristic of a set of bits that are candidates to be replicated from a source cluster to a target cluster. Such a set of bits can comprise specific contents (e.g., file contents or executable code), or metadata or containers (e.g., folders or directories), and such bits can correspond to physical storage entities (e.g., files, blocks, ranges of blocks, etc.) or such bits can correspond to logical storage entities (e.g., virtual disks, objects, etc.).

As used herein, a replication session refers to the period of time during which a source cluster communicates with a target cluster to carry out data replication activities by and between the source cluster and the target cluster.

In the foregoing deduplication scenario, a deduplication label (e.g., a label designation “D”) is codified into a cluster data manifest. Additionally or alternatively, a deduplication counter can be used to keep track of the number of entries that point to the deduplicated data. There are many embodiments where a deduplication count is maintained as storage metadata that is maintained in manners independent of the foregoing manifest. For example, a deduplication count field might be available for each extent in the cluster. This facilitates a wide range of deduplication scenarios where the decision to deduplicate or not depends on a threshold of a deduplication count value that is codified into a deduplication counter field that is associated with each extent (e.g., block, range of blocks, etc.).

Those of skill in the art will recognize that there are various cluster configurations where deduplication is linked with a replication factor. In such a case, determining deduplication status of an item may take into account a replication factor. Consider a cluster that is configured to have a replication factor of 2, which means that there is purposely two copies of every data item on the cluster, thus allowing for improved availability (e.g., noting that there is the other copy available in the case of a loss of one of the copies). As such, the semantics of deduplication has to take into account the replication factor. Strictly as one example, the replication factor might be codified into a deduplication counter field. As such, non-deduplicated data items would have a deduplication count value equal to the replication factor, whereas a data item that has been subjected to deduplication would have a deduplication count value greater than the replication factor. As an alternative, a replication factor value and a deduplication counter value can be stored in separate fields.

In some embodiments replication is not enabled (e.g., the system does not automatically and/or purposely store multiple copies of the same item). In such embodiments, the deduplication count value refers simply to the number of references to the bits of a particular data item. As such, when the deduplication count value is decremented to zero, then then the actual bits corresponding to the deduplicated data item can be deleted. Deduplicated data items can be larger containers (e.g., large files) or deduplicated data items can be smaller items such as portions of a file, or single blocks, or multiple blocks that combine to define an extent.

Further details regarding general approaches to defining and managing extents are described in U.S. Pat. No. 8,850,130 entitled “METADATA FOR MANAGING I/O AND STORAGE FOR A VIRTUALIZATION” issued on Sep. 30, 2014, which is hereby incorporated by reference in its entirety.

Techniques for handling cluster-to-cluster data replication in the presence of deduplicated extents is shown and described as pertains to FIG. 3C.

FIG. 3C shows a flowchart 3C00 that illustrates high-performance inter-cluster replication where the two clusters implement counter-based deduplication. As an option, one or more variations of flowchart 3C00 or any aspect thereof may be implemented in the context of the architecture and functionality of the embodiments described herein and/or in any environment.

The figure is being presented to illustrate how, at a source cluster, any candidate data item of any type or of any form or of any size can be divided into constituent components, which constituent components are then selectively stored, or not stored, or duplicatively stored at a target cluster. In this particular embodiment, a determination is made as to whether or not a particular extent item that constitutes a data item is worthy of being subjected to deduplication processing. This is because, since deduplication processing consumes at least some computing resources, it follows that deduplication processing should not be wasted on extent items that are not even subject to deduplication. In this embodiment, decision 344 calculates a deduplication status 345, and on the basis of such a deduplication status, makes the determination as to whether or not a particular extent item should remain in the set if extent items that were converted into extent item IDs in accordance with step 342. By identifying extents that are not to be subjected to deduplication processing and then removing those extent item IDs from the set (step 346), deduplication processing is only applied to the remaining extent items which are then subjected to the deduplication processing of step 349 through step 362.

As used herein, a deduplication status refers to an indicator as to whether or not a particular set of bits is subject to deduplication processing. For example, suppose that a particular set of bits comprises a data item that is used as a virtual disk. Then further suppose that there is deduplication status (e.g., to be subject to deduplication) that corresponds to the entire virtual disk. In some implementations, constituents of a virtual disk are themselves data items (e.g., blocks or extents), one or more of which has its own corresponding deduplication status.

Now, as pertaining to the specific implementation as depicted in FIG. 3C, there are: (1) a first set of steps and decisions (e.g., step 340, step 342, decision 344 and step 346) that are configured, singly or in combination, to avoid deduplication processing over any extent items that are not deduplication items; (2) a second set of steps and decisions (e.g., step 349, step 356 and decision 354) serve to populate a data item manifest with deduplication counter values for the constituent components of data items that are deduplication items; and (3) a third set of steps (e.g., step 358, step 360 and step 362) that serve to replicate constituent components of data items that are deduplication items—but only when the target cluster requests the data (e.g., the actual bits) of a particular extent item.

In this specific embodiment, the shown source cluster operations 336 commence at step 340, where a next replication candidate data item is identified. This identification can happen for many reasons, such as when the source cluster is traversing through a series of folders and/or when the source cluster is processing a list of data items that are identified as replication candidates. Any particular data item is then considered for division into constituent components and, if the data item is divisible, the data item is then divided into extent items (step 342). Next, for each extent item (e.g., block) that results from the division of the data item, the extent item is checked to see if that particular extent item is a candidate for deduplication processing. Such a check can use any known technique, possibly including checking for deduplication indications that are associated with the particular extent item. If the particular extent item is not a deduplication item, then the “No” branch of decision 344 is taken and one or more target cluster operations 338 are invoked so as to store the extent data corresponding to the extent item. In some embodiments, and as shown, the extent item corresponds to an extent ID which is stored at the target cluster in association with the extent data. At the target cluster, the data item manifest is updated to reflect the storage of the extent item and its extent ID at the target cluster. The replicated extent item is then removed from the set of extent items that are being processed at the source cluster.

On the other hand, if the particular extent item is a deduplication item, then the “Yes” branch of decision 344 is taken and the next extent item is processed. As such, when the FOR EACH loop completes, then the remaining entries in the set of extent items are to be considered as deduplication items. In this embodiment, processing of deduplicated items includes populating a data item manifest with deduplication counter values for the constituent components of data items that are deduplication items, and sending replication data, as needed, to actually replicate, at the target cluster, the constituent components of deduplication data items.

There two cases of particular interest. In a first case, if the target cluster does already have storage of the bits of the subject deduplicated data item, then the source need not send the bits subject deduplicated data item again. However, in this case, the target cluster still needs to keep track of the number of references to the deduplicated data, so a deduplication counter at the target (e.g., in an entry of data item manifest) would be incremented. In the second case, the target cluster does not yet have the bits of the subject deduplicated data item, so the target cluster sends a request to the source cluster, requesting that the source cluster locate and send the bits corresponding to the deduplicated data (step 358). This can be done asynchronously or synchronously. In either case, in accordance with this particular embodiment, the data manifest at the target cluster is populated during the inter-cluster messaging with deduplication counter values.

To accomplish the foregoing population of the data item manifest with deduplication counter values, the remaining items in the set of extent items are processed individually as follows: (1) the extent item ID is sent to the target cluster (step 349); (2) if the extent item ID is already found in the manifest (decision 354), then the deduplication counter is incremented (step 356) and the deduped data is not sent (again) from the source to the target. On the other hand, if the extent item ID is not found in the manifest (decision 354), then the target cluster will request the data corresponding to the extent item ID that was not found in the manifest. By avoiding sending the data corresponding to the extent item ID that was not found in the manifest until such time as it is known to be needed at the target cluster saves significant computing resources (e.g., CPU cycles, network bandwidth, etc.) as compared to naive approaches that send the data corresponding to the extent item ID without knowing whether or not the target cluster might already have a copy.

A request for data corresponding to an extent ID can be handled synchronously or asynchronously. Either way, the source cluster will eventually attempt to satisfy the target cluster's request for the extent data. When the source cluster does satisfy the target cluster's request for the extent data, the source sends both the extent data as well as its corresponding extent ID to the target cluster, upon which event the target cluster adds the extent ID to the manifest (step 360), stores the extent data, and initializes the deduplication counter for the corresponding extent ID.

It should be noted that the foregoing deduplication techniques are not strictly limited to having exactly one copy of the deduplicated data on a given cluster. In some cases, deduplicated data is purposely duplicated more than once so as to accommodate computing cluster topologies and configurations. For example, one particular node of a cluster might be designated as a storage-only node or a staging node, and that node might be populated with data that is relatively infrequently accessed. However a different node or nodes of the same cluster might be dedicated to a particular workload where the same deduplicated data is accessed frequently. In such a configuration, it is possible that some deduplicated data is purposely duplicated more than once. Accordingly, a deduplication count threshold is defined so as to ensure that, during replication from a source cluster to a target cluster, the correct number of copies of deduplicated data is provided at the target cluster.

Now, referring back to decision 344, some mechanism needs to be provided to determine, for any arbitrary extent, whether or not the extent is a deduplication item. Deduplication items include extent items that are indicated in metadata as deduplicated extents. Some mechanism needs to be provided to locate the actual data that corresponds to a deduplication item. One possible technique for accomplishing the foregoing is shown and described as pertains to FIG. 3D.

FIG. 3D depicts an example deduplication metadata traversal 3D00 as used in high-performance inter-cluster replication where the two clusters implement counter-based deduplication. As an option, one or more variations of the deduplication metadata traversal 3D00 or any aspect thereof may be implemented in the context of the architecture and functionality of the embodiments described herein and/or in any environment.

As shown, a particular data item 109 has a logical representation 368. This may be a name or range any portion of which name or range can be used as an ID. For example, if the entire movie file for the movie “Starman's Revenge” is a deduplication item, then a unique value (e.g., a SHA1 hash value) can be used to locate information about the movie file in metadata 364. There might be additional entries (e.g., directory entries) for the movie “Starman's Revenge,” however if the entry indeed corresponds to the same movie file, then its SHA1 hash value will be the same as other entries. Accordingly, and referring to the depiction of FIG. 3D, when metadata corresponding to an entry based on the SHA1 value1 is accessed, it points to physical storage 366 that comprises the one single occurrence of the actual bits of the movie file. In the shown example, its corresponding deduplication counter (CTR1) holds the count value ‘2’.

Of course, the situation can arise where a particular data item or constituent division of a particular data item is known to be deduplicated data, but for which, at that particular moment in time, there is only the first copy. This is depicted by ID2. In this case, the SHA1 value2 corresponding to the bits of the corresponding data item depicted by ID2 has a metadata entry. In the shown example, its corresponding deduplication counter (CTR2) holds the count value ‘1’.

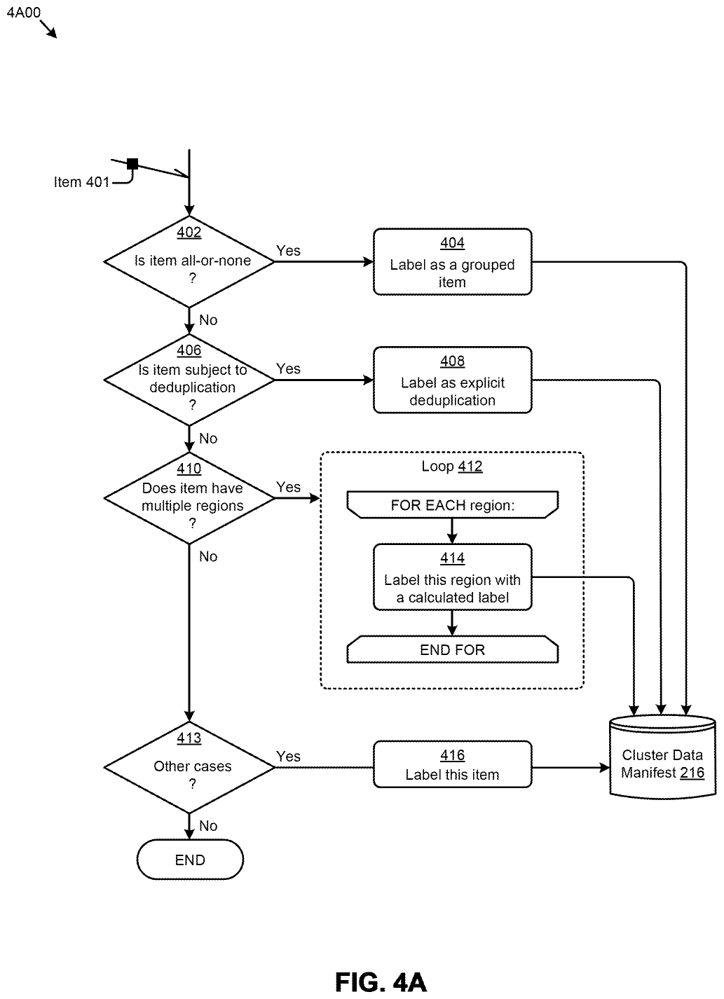

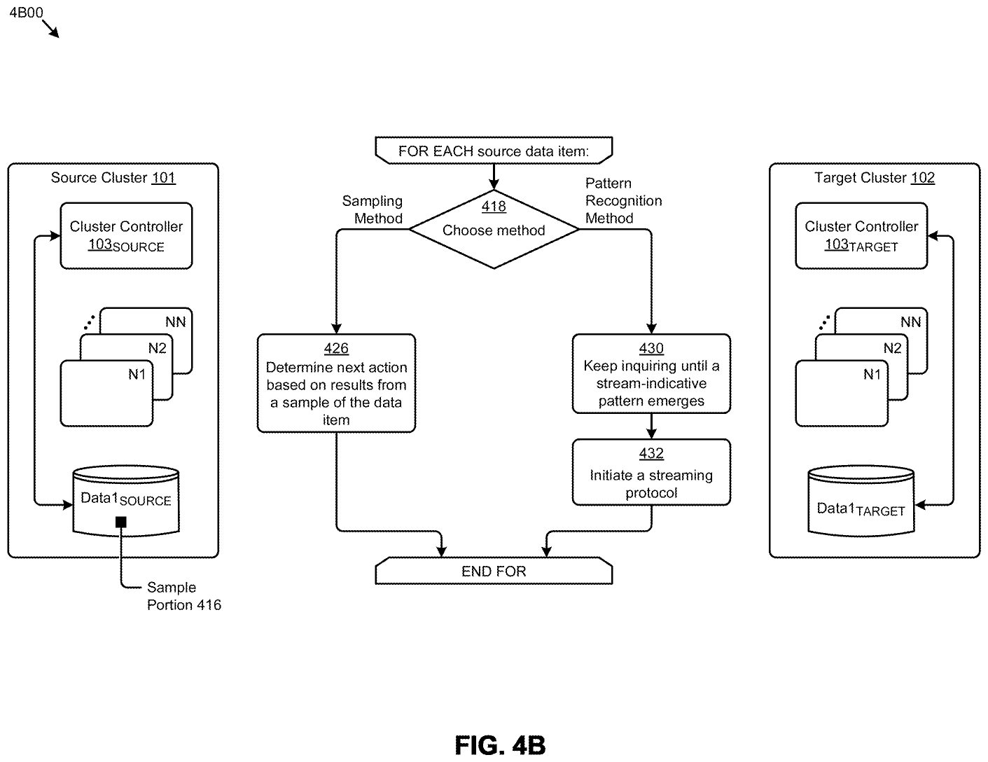

As can now be understood, there are many further use cases and scenarios where the then-current status of a particular data item as reported by a target cluster is used to inform the source cluster whether or not the particular data item should be the subject of replication at that particular moment in time. Further, there are many use cases where, responsive to an inquiry by the source cluster, the then-current status of a particular data item as reported by a target cluster is used to inform the source cluster whether or not constituents of the particular data item can be streamed (e.g., without further inquiries) to the target cluster. Still further, there are many cases where knowledge of particular characteristics of a subject data item can be codified into a label and/or other metadata, which label and/or other metadata is in turn used to inform or imply attributes or conditions that are used in making a determination of how a subject data item should be treated during the course of a replication session. Labeling variations, including underlying use cases are shown and described as pertains to FIG. 4A.

FIG. 4A depicts several example labeling cases 4A00 as are found in systems that dynamically determine when to carry out an inquiry phase of an inter-cluster replication protocol and when to carry out a data send phase of an inter-cluster replication protocol. As an option, one or more variations of use cases 4A00 or any aspect thereof may be implemented in the context of the architecture and functionality of the embodiments described herein and/or in any environment.

The figure is being presented to exemplify labeling cases where particular characteristics of a subject data item are codified into a label having particular underlying semantics such that the determination as to when to carry out an inquiry phase of an inter-cluster replication protocol and when to carry out a data send phase of an inter-cluster replication protocol can be made based on the label and/or semantics thereof. Further, the figure is being presented to illustrate how a label can be applied not only to a particular data item as a whole, but also to one or more regions of a data item, which regions constitute the data item as a whole.

The shown flow commences upon provisioning of item 401 (e.g., a data item or a group of data items). The item is then checked for specific characteristics. Additionally the environment in which the item is situated can be checked for specific conditions. Based on a set of determined characteristics and/or environmental conditions, entries corresponding to an item are made into cluster data manifest 216. A particular item 401 can be associated with any number of specific characteristics. Labels beyond those heretofore described can be generated dynamically.

Although FIG. 4A depicts several labeling cases, these are merely examples for purposes of illustration, and other labeling cases are possible. The selected examples shown, include: (1) labeling an item with a value corresponding to an all-or-none group label value (e.g., via decision 402 and operation 404), (2) labeling an item as being subject to deduplication rules (e.g., via decision 406 and operation 408), and (3) labeling an item and/or its constituent multiple regions as being subject to region-specific handling (e.g., via decision 410 and loop 412).

In the latter case, loop 412 iterates over each region of the item. During these iterations, a region-specific label is calculated (step 414). The calculated region-specific label is stored in the cluster data manifest in association with the item. In some cases, a cluster data manifest supports codification of multiple labels in a single row. In other cases, a cluster data manifest has only one label per row. In some cases, there are as many rows pertaining to an item as the item has regions.

Strictly as an illustrative example, a virtual machine image might be divided into an immutable region (e.g., a region of executable code) and a mutable region (e.g., a region that comprises VM-specific configuration and/or status data). As pertains to inter-cluster replication, the immutable region might be handled differently from the mutable region. More specifically, the mutable region might be, or correspond to, a segment of code that derives from a “gold disk”, and as such that region of the VM image might be populated only on demand (e.g., in the event of a disaster) rather than prospectively. For VM images that are, or include, clones of large portions of an operating system such as Windows™, this mechanism whereby large portions of immutable data are deduplicated can afford a huge savings in terms of computing resources used (e.g., network bandwidth used, CPU cycles used, etc.) when replicating from a source node to a target node. As such, a virtual machine image might comprise a first region that is a code region and a second region that is a data region. The data region can be streamed from the source cluster to the target cluster. In some situations, the code region can be deduplicated as well.

As another example, various individual ones of multiple regions of a vDisk can be labeled with a calculated label. In some cases, it can be determined that a particular region of a vDisk is a copy of, or descendant of, an involatile “gold disk”, in which case that region might be labeled with a “GDC” label or variant thereof. In some cases, it can be determined that a particular region of a vDisk is, or comprises, or refers to a deduplicated data item, in which case that region might be labeled with a “D” label to indicate that the region is not to be replicated at the target cluster.

The foregoing decisions and labeling steps are merely examples. Other labels are reasonable and can be entered into a cluster data manifest. One mechanism for applying other labels is depicted by the “No” branches of decision 410, decision 413 and step 416. More particularly, various other labels, either solely or in combination with other labels and/or conditions may be dispositive of, or influence, a dynamic determination of how ongoing protocol exchanges between a source cluster and a target cluster can be carried out.

FIG. 4B depicts several example protocol phase determination methods 4B00 as are found in systems that dynamically determine when to carry out an inquiry phase of an inter-cluster replication protocol and when to carry out a data send phase of an inter-cluster replication protocol. As an option, one or more variations of example protocol phase determination methods 4B00 or any aspect thereof may be implemented in the context of the architecture and functionality of the embodiments described herein and/or in any environment.

At any moment in time, a target cluster can be provisioned, designated as a replication site, and brought up to an operational state. This brings to bear the problem that the target cluster needs to be configured with a data set that would serve for recovery in the event of a disaster that had affected the source cluster. Accordingly, there needs to be some efficient technique for populating data at the target, even if the target cluster has not stored and/or characterized its data. More specifically, the source cluster needs to be able to make decisions as to which protocol phases can be advantageously eliminated in the midst of a partially completed (or not started) inter-cluster replication protocol. Accordingly, the operation flow of FIG. 4B handles cases where the target cluster does not have populated data and/or has not characterized its data to the extent that such data has been stored and/or labeled.

One case for efficiently populating data at the target cluster (even if the target cluster has not stored and/or characterized its data) is depicted by the “Sampling Method” branch of decision 418 and operation 426. To illustrate, consider the case where the source cluster defines a group of data items (e.g., in a folder or directory) composed of individual constituent data items (e.g., files). The source cluster can randomly select from among individual constituent data items so as to sample only a subset of the individual constituent data items (e.g., sample portion 416) and, upon determination that all or substantially all of the constituent data items in the corpus would be most efficiently communicated to the target cluster using a streaming protocol, the source can initiate such a streaming protocol to push the entire group of data items to the target cluster. In this manner, large amounts of data from the source cluster can be replicated at the target cluster—yet without incurring processing latencies associated with further inquiries pertaining to the particular constituent data items.

On the other hand, if the group of data items was substantially composed of items that are explicitly to be deduplicated, the source cluster can iterate through the inquiry phase so as to cause the cluster data manifest at the target to be populated with entries corresponding to the explicitly deduplicated items—yet without further duplicating data that is known to be explicitly deduplicated data.

In an alternative case, an efficient protocol selection can be based on pattern recognition. This is depicted by the “Pattern Recognition Method” branch of decision 418. When this branch is taken, the source cluster makes continuous inquiries to the target cluster (operation 430), while keeping a record of the target cluster's responses to the inquiries. When a pattern emerges, then based on the specific pattern, a more efficient protocol is selected. As another example, and corresponding to the particular depiction of FIG. 4B, if a pattern emerges that, for each inquiry pertaining to a data item, the target responds that it does not have the data item, the source cluster might move to a streaming protocol (operation 432) to cover a (possibly large) set of data items.

The foregoing cases are presented merely for illustrative purposes. Additional cases and corresponding efficient replication methods are possible. For example, consider that, for a particular set of vDisks, statistics are kept as to how many times and at which offsets the data was sent to the target using a streaming protocol. These statistics can be used in the context of future cluster-to-cluster replications.

### System Architecture Overview

### Additional System Architecture Examples

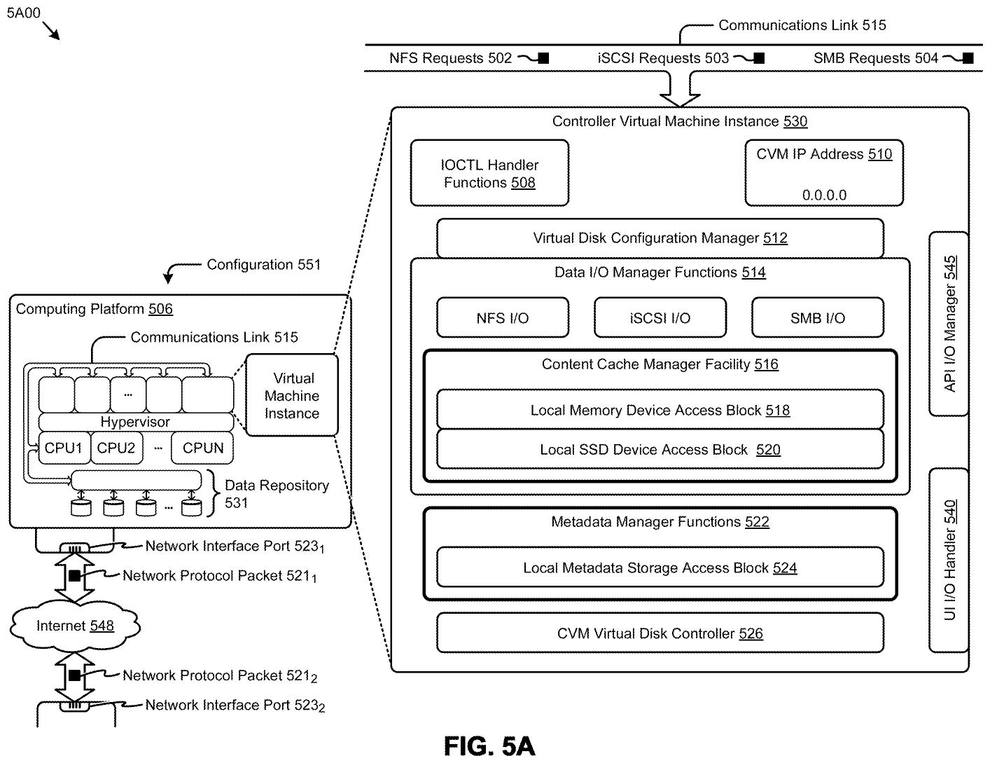

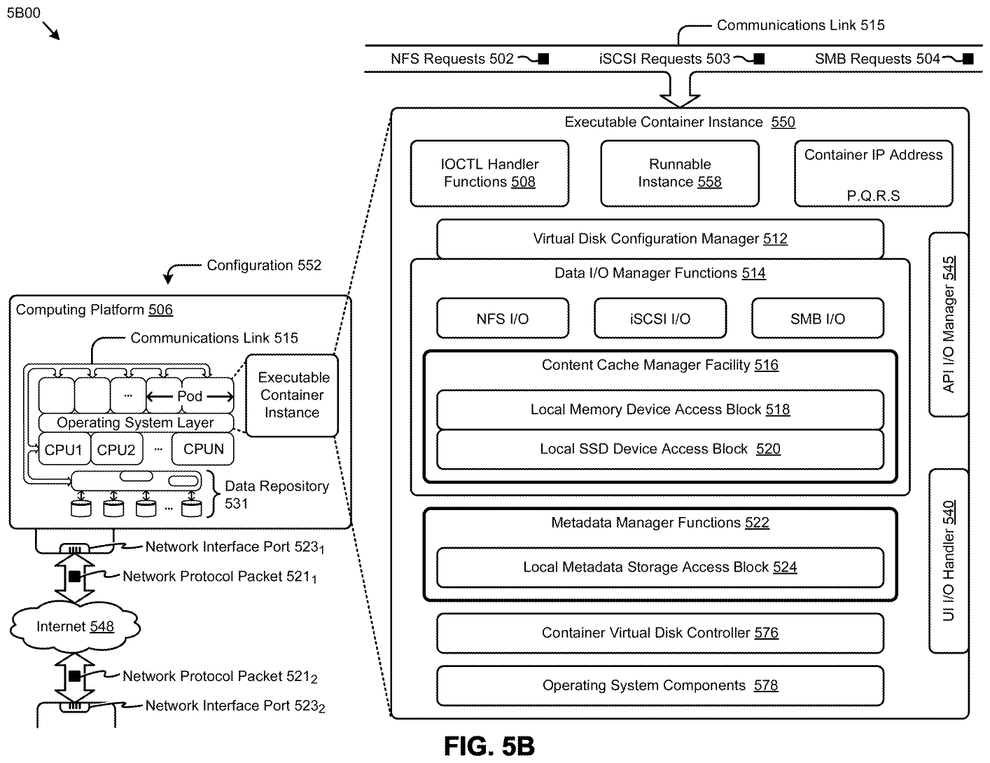

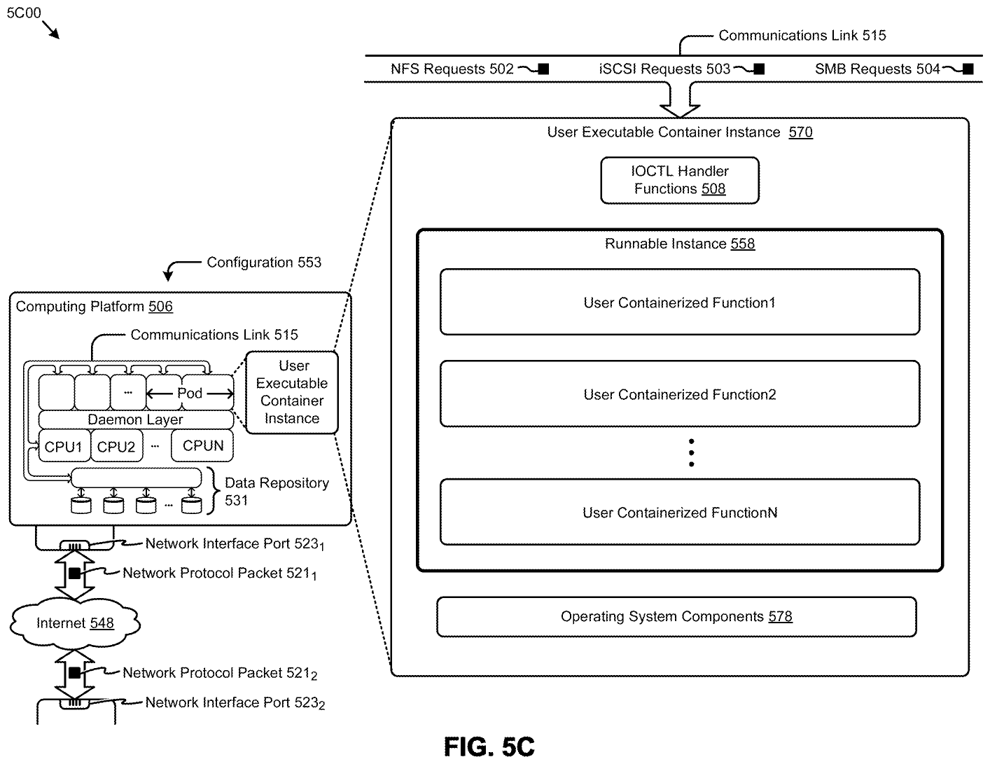

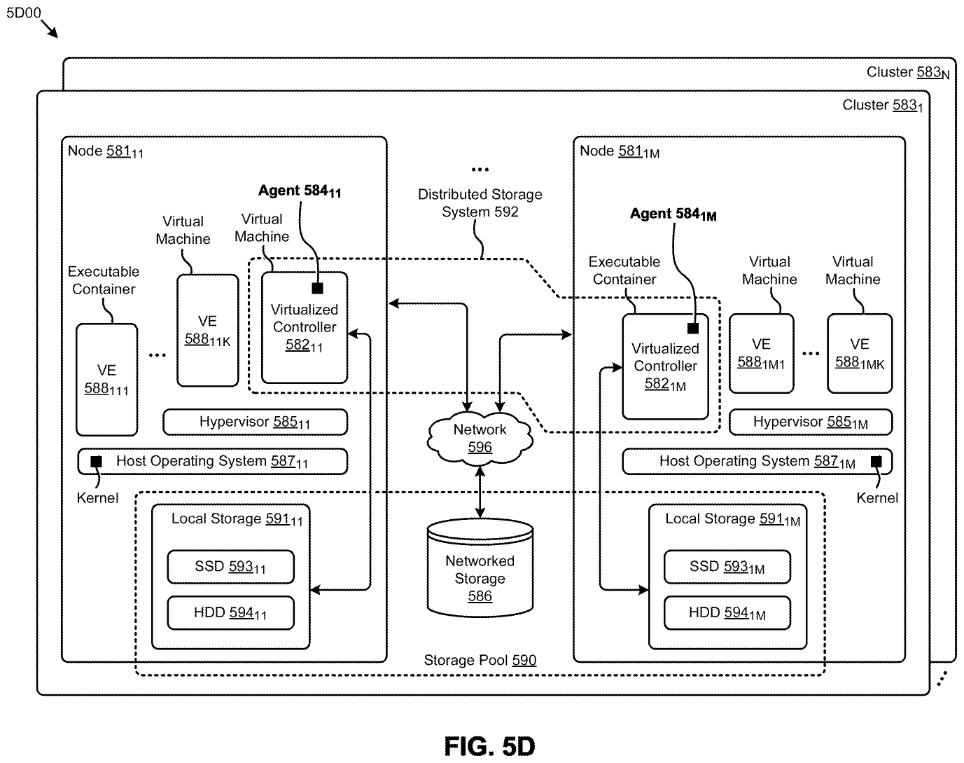

All or portions of any of the foregoing techniques can be partitioned into one or more modules and instanced within, or as, or in conjunction with, a virtualized controller in a virtual computing environment. Some example instances within various virtual computing environments are shown and discussed as pertains to FIG. 5A, FIG. 5B, FIG. 5C, and FIG. 5D.

FIG. 5A depicts a virtualized controller as implemented in the shown virtual machine architecture 5A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as a layer in a hypervisor). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 5A00 comprises a collection of interconnected components suitable for implementing embodiments of the present disclosure and/or for use in the herein-described environments. Moreover, virtual machine architecture 5A00 includes a virtual machine instance in configuration 551 that is further described as pertaining to controller virtual machine instance 530. Configuration 551 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 530.

In this and other configurations, a controller virtual machine instance receives block I/O storage requests as network file system (NFS) requests in the form of NFS requests 502, and/or internet small computer storage interface (iSCSI) block IO requests in the form of iSCSI requests 503, and/or Samba file system (SMB) requests in the form of SMB requests 504. The controller virtual machine (CVM) instance publishes and responds to an internet protocol (IP) address (e.g., CVM IP address 510). Various forms of input and output can be handled by one or more IO control handler functions (e.g., IOCTL handler functions 508) that interface to other functions such as data IO manager functions 514 and/or metadata manager functions 522. As shown, the data IO manager functions can include communication with virtual disk configuration manager 512 and/or can include direct or indirect communication with any of various block IO functions (e.g., NFS IO, iSCSI IO, SMB IO, etc.).

In addition to block IO functions, configuration 551 supports IO of any form (e.g., block IO, streaming IO, packet-based IO, HTTP traffic, etc.) through either or both of a user interface (UI) handler such as UI IO handler 540 and/or through any of a range of application programming interfaces (APIs), possibly through API IO manager 545.

Communications link 515 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 530 includes content cache manager facility 516 that accesses storage locations, possibly including local dynamic random access memory (DRAM) (e.g., through local memory device access block 518) and/or possibly including accesses to local solid state storage (e.g., through local SSD device access block 520).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 531, which in turn can be formatted into any one or more storage areas, and which can comprise parameterized storage accessible by a key (e.g., a file name, a table name, a block address, an offset address, etc.). Data repository 531 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 524. The data repository 531 can be configured using CVM virtual disk controller 526, which can in turn manage any number or any configuration of virtual disks.

Execution of a sequence of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 551 can be coupled by communications link 515 (e.g., backplane, LAN, PSTN, wired or wireless network, etc.) and each instance may perform respective portions of sequences of instructions as may be required to practice embodiments of the disclosure.

The shown computing platform 506 is interconnected to the Internet 548 through one or more network interface ports (e.g., network interface port 523₁ and network interface port 523₂). Configuration 551 can be addressed through one or more network interface ports using an IP address. Any operational element within computing platform 506 can perform sending and receiving operations using any of a range of network protocols, possibly including network protocols that send and receive packets (e.g., network protocol packet 521₁ and network protocol packet 521₂).

Computing platform 506 may transmit and receive messages that can be composed of configuration data and/or any other forms of data and/or instructions organized into a data structure (e.g., communications packets). In some cases, the data structure includes program instructions (e.g., application code) communicated through the Internet 548 and/or through any one or more instances of communications link 515. Received program instructions may be processed and/or executed by a CPU as it is received and/or program instructions may be stored in any volatile or non-volatile storage for later execution. Program instructions can be transmitted via an upload (e.g., an upload from an access device over the Internet 548 to computing platform 506). Further, program instructions and/or the results of executing program instructions can be delivered to a particular user via a download (e.g., a download from computing platform 506 over the Internet 548 to an access device).

Configuration 551 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to dynamically determining when to carry out an inquiry phase of an inter-cluster replication protocol and when to carry out a data send phase of an inter-cluster replication protocol. In some embodiments, a module may include one or more state machines and/or combinational logic used to implement or facilitate the operational and/or performance characteristics pertaining to dynamically determining when to carry out an inquiry phase of an inter-cluster replication protocol and when to carry out a data send phase of an inter-cluster replication protocol.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of dynamically determining when to carry out an inquiry phase of an inter-cluster replication protocol and when to carry out a data send phase of an inter-cluster replication protocol). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to dynamically determining when to carry out an inquiry phase of an inter-cluster replication protocol and when to carry out a data send phase of an inter-cluster replication protocol, and/or for improving the way data is manipulated when performing computerized operations pertaining to maintaining a manifest that characterizes stored data items.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 5B depicts a virtualized controller implemented by containerized architecture 5B00. The containerized architecture comprises a collection of interconnected components suitable for implementing embodiments of the present disclosure and/or for use in the herein-described environments. Moreover, the shown containerized architecture 5B00 includes an executable container instance in configuration 552 that is further described as pertaining to executable container instance 550. Configuration 552 includes an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 550). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls”, “dir”, etc.). The executable container might optionally include operating system components 578, however such a separate set of operating system components need not be provided. As an alternative, an executable container can include runnable instance 558, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 576. Such a container virtual disk controller can perform any of the functions that the aforementioned CVM virtual disk controller 526 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 5C depicts a virtualized controller implemented by a daemon-assisted containerized architecture 5C00. The containerized architecture comprises a collection of interconnected components suitable for implementing embodiments of the present disclosure and/or for use in the herein-described environments. Moreover, the shown daemon-assisted containerized architecture includes a user executable container instance in configuration 553 that is further described as pertaining to user executable container instance 570. Configuration 553 includes a daemon layer (as shown) that performs certain functions of an operating system.

User executable container instance 570 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 558). In some cases, the shown operating system components 578 comprise portions of an operating system, which portions are interfaced with or included in the runnable instance and/or any user containerized functions. In this embodiment of a daemon-assisted containerized architecture, the computing platform 506 might or might not host operating system components other than operating system components 578. More specifically, the shown daemon might or might not host operating system components other than operating system components 578 of user executable container instance 570.

The virtual machine architecture 5A00 of FIG. 5A and/or the containerized architecture 5B00 of FIG. 5B and/or the daemon-assisted containerized architecture 5C00 of FIG. 5C can be used in any combination to implement a distributed platform that contains multiple servers and/or nodes that manage multiple tiers of storage where the tiers of storage might be formed using the shown data repository 531 and/or any forms of network accessible storage. As such, the multiple tiers of storage may include storage that is accessible over communications link 515. Such network accessible storage may include cloud storage or networked storage (e.g., a SAN or storage area network). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 551 of FIG. 5A) to manage the interactions between the underlying hardware and user virtual machines or containers that run client software.

Distinct from user virtual machines or user executable containers, a special controller virtual machine (e.g., as depicted by controller virtual machine instance 530) or as a special controller executable container is used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 5D depicts a distributed virtualization system in a multi-cluster environment 5D00. The shown distributed virtualization system is configured to be used to implement the herein disclosed techniques. Specifically, the distributed virtualization system of FIG. 5D comprises multiple clusters (e.g., cluster 583₁, . . . , cluster 583_{N}) comprising multiple nodes that have multiple tiers of storage in a storage pool. Representative nodes (e.g., node 581₁₁, . . . , node 581_{1M}) and storage pool 590 associated with cluster 583₁ are shown. Each node can be associated with one server, multiple servers, or portions of a server. The nodes can be associated (e.g., logically and/or physically) with the clusters. As shown, the multiple tiers of storage include storage that is accessible through a network 596, such as a networked storage 586 (e.g., a storage area network or SAN, network attached storage or NAS, etc.). The multiple tiers of storage further include instances of local storage (e.g., local storage 591₁₁, . . . , local storage 591_{1M}). For example, the local storage can be within or directly attached to a server and/or appliance associated with the nodes. Such local storage can include solid state drives (SSD 593₁₁, . . . , SSD 593_{1M}), hard disk drives (HDD 594₁₁, . . . , HDD 594_{1M}), and/or other storage devices.

As shown, any of the nodes of the distributed virtualization system can implement one or more user virtualized entities (e.g., VE 588₁₁₁, . . . , VE 588_{11K}, . . . , VE 588_{1M1}, . . . , VE 588_{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 587₁₁, . . . , host operating system 587_{1M}), while the VMs run multiple applications on various respective guest operating systems. Such flexibility can be facilitated at least in part by a hypervisor (e.g., hypervisor 585₁₁, . . . , hypervisor 585_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers are implemented at the nodes in an operating system virtualization environment or container virtualization environment. The executable containers comprise groups of processes and/or resources (e.g., memory, CPU, disk, etc.) that are isolated from the node host computer and other containers. Such executable containers directly interface with the kernel of the host operating system (e.g., host operating system 587₁₁, . . . , host operating system 587_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 590 by the VMs and/or the executable containers.

Multiple instances of such virtualized controllers can coordinate within a cluster to form the distributed storage system 592 which can, among other operations, manage the storage pool 590. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 581₁₁ can interface with a controller virtual machine (e.g., virtualized controller 582₁₁) through hypervisor 585₁₁ to access data of storage pool 590. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 592. For example, a hypervisor at one node in the distributed storage system 592 might correspond to software from a first vendor, and a hypervisor at another node in the distributed storage system 592 might correspond to a second software vendor. As another virtualized controller implementation example, executable containers can be used to implement a virtualized controller (e.g., virtualized controller 582_{1M}) in an operating system virtualization environment at a given node. In this case, for example, the virtualized entities at node 581_{1M} can access the storage pool 590 by interfacing with a controller container (e.g., virtualized controller 582_{1M}) through hypervisor 585_{1M} and/or the kernel of host operating system 587_{1M}.

In certain embodiments, one or more instances of an agent can be implemented in the distributed storage system 592 to facilitate the herein disclosed techniques. Specifically, agent 584₁₁ can be implemented in the virtualized controller 582₁₁, and agent 584_{1M} can be implemented in the virtualized controller 582_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to maintaining a manifest that characterizes stored data items can be brought to bear through implementation of any one or more of the foregoing techniques. Moreover, any aspect or aspects of when to send an inquiry before sending data versus when to just send data without a corresponding inquiry can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts for replication of a data item between two computing clusters, the acts comprising:
identifying a plurality of data items for copying from a source cluster to a target cluster; and
at the source cluster, dynamically selecting between a first protocol and a second protocol for copying at least some of the plurality of data items, wherein said selecting is based upon results of carrying out the first protocol on an initial subset of the plurality of data items.

2. The non-transitory computer readable medium of claim 1, wherein the data item is at least one of, a folder, a virtual disk, or a metadata range.

3. The non-transitory computer readable medium of claim 1, wherein the data item is a virtual machine image comprising a first region that is a code region and a second region that is a data region, and wherein the data region is streamed from the source cluster to the target cluster.

4. The non-transitory computer readable medium of claim 1, wherein a data item label indicates that the data item has multiple regions.

5. The non-transitory computer readable medium of claim 1, wherein the at least a portion of the data item is labeled with an all-or-none group label value.

6. The non-transitory computer readable medium of claim 1, wherein a presence of the data item at the target cluster is based at least in part on SHA1 hash value of the data item.

7. The non-transitory computer readable medium of claim 1, wherein dynamically selecting between the first protocol and the second protocol comprises evaluating a pattern metric.

8. The non-transitory computer readable medium of claim 1, wherein dynamically selecting between the first protocol and the second protocol comprises evaluating an affinity metric.

9. A method for replication of a data item between two computing clusters, the method comprising:
identifying a plurality of data items for copying from a source cluster to a target cluster; and
at the source cluster, dynamically selecting between a first protocol and a second protocol for copying at least some of the plurality of data items, wherein said selecting is based upon results of carrying out the first protocol on an initial subset of the plurality of data items.

10. The method of claim 9, wherein the data item is at least one of, a folder, a virtual disk, or a metadata range.

11. The method of claim 9, wherein the data item is a virtual machine image comprising a first region that is a code region and a second region that is a data region, and wherein the data region is streamed from the source cluster to the target cluster.

12. The method of claim 9, wherein a data item label indicates that the data item has multiple regions.

13. The method of claim 9, wherein the at least a portion of the data item is labeled with an all-or-none group label value.

14. The method of claim 9, wherein a presence of the data item at the target cluster is based at least in part on SHA1 hash value of the data item.

15. The method of claim 9, wherein dynamically selecting between the first protocol and the second protocol comprises evaluating a pattern metric.

16. The method of claim 9, wherein dynamically selecting between the first protocol and the second protocol comprises evaluating an affinity metric.

17. A system for replication of a data item between two computing clusters, the system comprising:
a processor that executes the sequence of instructions to cause the processor to perform acts comprising,
identifying a plurality of data items for copying from a source cluster to a target cluster; and
at the source cluster, dynamically selecting between a first protocol and a second protocol for copying at least some of the plurality of data items, wherein said selecting is based upon results of carrying out the first protocol on an initial subset of the plurality of data items.

18. The system of claim 16, wherein the data item is at least one of, a folder, a virtual disk, or a metadata range.

19. The system of claim 16, wherein the data item is a virtual machine image comprising a first region that is a code region and a second region that is a data region, and wherein the data region is streamed from the source cluster to the target cluster.

20. The system of claim 16, wherein a data item label indicates that the data item has multiple regions.

21. The system of claim 16, wherein the at least a portion of the data item is labeled with an all-or-none group label value.

22. The system of claim 16, wherein a presence of the data item at the target cluster is based at least in part on SHA1 hash value of the data item.

23. The system of claim 16, wherein dynamically selecting between the first protocol and the second protocol comprises evaluating a pattern metric.

24. The system of claim 16, wherein dynamically selecting between the first protocol and the second protocol comprises evaluating an affinity metric.

25. A non-transitory computer readable medium having stored thereon a sequence of instructions which, when stored in memory and executed by a processor cause the processor to perform acts for replication of a data item between two computing clusters, the acts comprising:
identifying a data item for copying from a source cluster to a target cluster; and
at the source cluster, dynamically selecting between a first protocol and a second protocol to determine whether a copy of the data item is already present at the target cluster, wherein said selecting is based on a deduplication status for the data item stored at the source cluster.

26. The non-transitory computer readable medium of claim 25, wherein presence of the data item is based at least in part on SHA1 hash value of the data item.

27. The non-transitory computer readable medium of claim 25, wherein, the deduplication status indicates that the data item is subject to deduplication.

28. A method for replication of a data item between two computing clusters, the acts comprising:
identifying a data item for copying from a source cluster to a target cluster; and
at the source cluster, dynamically selecting between a first protocol and a second protocol to determine whether a copy of the data item is already present at the target cluster, wherein said selecting is based on a deduplication status for the data item stored at the source cluster.

29. The method of claim 28, wherein presence of the data item is based at least in part on SHA1 hash value of the data item.

30. The method of claim 28, wherein, the deduplication status indicates that the data item is subject to deduplication.
